(19) United States
(12) Patent Application Publication
(10) Pub. No.: US 2021/0357872 A1
(43) Pub. Date: Nov. 18, 2021

(54) JOB OPENING AND CANDIDATE MATCHING SYSTEM

(71) Applicant: Torre Labs, Inc., Napa, CA (US)

(72) Inventors: Daniela Avila Gomez, Cajicá (CO); Alex Henriquez Torrenegra, Napa, CA (US); David Montaño, Bogotá (CO); Andrés Felipe Cajiao Villarraga, Bogotá (CO)

(73) Assignee: Torre Labs, Inc., Napa, CA (US)

(21) Appl. No.: 17/320,162

(22) Filed: May 13, 2021

Related U.S. Application Data
(60) Provisional application No. 63/025,382, filed on May 15, 2020.

(51) Int. Cl. G06Q 10/10; G06Q 30/02; G06F 16/2457; G06F 16/248; G06F 3/14

(52) U.S. Cl. CPC G06Q 10/1053; G06Q 30/0203; G06F 3/14; G06F 16/24578; G06F 16/248; G06Q 30/0201

(57) ABSTRACT

Computer-implemented methods and systems are provided that stores requirement data for a plurality of job openings, profile data for each user of a plurality of users, and job preference data for each user of the plurality of users. A first metric is generated that pertains to a particular job opening belonging to the plurality of job opening and a particular user belonging to the plurality of users based on the requirement data for the particular job opening and the profile data for the particular user. A second metric is generated that pertains to the particular job opening and the particular user based on the requirement data for the particular job opening and the job preference data for the particular user. A visual representations of the first metric and the second metric is display as part of a unitary display window or screen. Other aspects are described and claimed.

This application claims priority from U.S. Provisional Application No. 63/025,382, filed on May 15, 2020, which is hereby incorporated herein by reference in its entirety.

### BACKGROUND

### 1. Field

The present disclosure relates to computer software and systems. In particular, it relates to computer-implemented methods and systems that match job openings submitted by companies or other talent seekers (such as recruiters, hiring managers, etc.) to qualified job seekers.

### 2. State of the Art

A challenge common to companies seeking talented employees is finding the best set of candidates for the position available. A challenge common to some job seekers is finding a job opening that they are qualified for and that meets their own personal criteria. One standard practice among human resource departments is to create a job description for each open position, then advertise the position along with the description. Recruiters and job seekers then have to review and analyze these descriptions in order to determine a match between job seekers and particular jobs.

Some job search tools exist that attempt to show a job candidate how close a match the candidate's experience and qualifications are to a respective job opening. For example, a candidate may view a list of available job openings showing a percentage of how close their qualifications match the requirements of each job opening. However, such matching metrics do not give a full picture to the candidate of actually where they fall short in their qualifications for the job or where their deficiencies lie. Moreover, even if a job seeker's credentials match a job description, a talent seeker for the job opening has no way to know if a posted job opening actually satisfies any personal criteria or preferences of the potential qualified candidate.

In addition to talent seekers finding potential candidates who have matching qualifications, it is important that the posted job openings are a good fit for the job seeker and match their expectations. Job seekers have concerns about the aspirational aspects of the jobs for which they are applying. Job seekers may want to spend more time considering available jobs that closely match their personal criteria and spend less time considering other available jobs that do not closely fit their criteria. On the other hand, talent seekers usually do not have access to information about how well a job fits a job seeker's personal criterial. Such information, if available to talent seekers, could assist them in making less subjective recruitment decisions and improve employee retention by increasing job satisfaction.

### SUMMARY

To help talent seekers and job seekers save time and make more informed and less subjective recruitment decisions, systems and associated methods are provided that determine metrics and/or related rankings for job seeker users that pertain to a particular job opening. Visual representations of the metrics and the related rankings can be viewed by the job seeker users associated therewith as well as the talent seeker user that submitted or posted the job opening associated therewith. In embodiments, the metrics can include a first metric, hereinafter referred to as a job qualification fitness metric, which indicates how well a job seeker user's qualifications match the requirements of a particular job opening submitted or posted by a talent seeker user. The metrics can also include a second metric, hereinafter referred to as a job fitness metric, which indicates how well the aspects of the job opening match personal criteria or preferences of the job seeker user. In embodiments, the qualification fitness metric and job fitness metric can be represented as a percentage value, 0% representing no match to 100% representing a full match. In embodiments, the systems and methods are dual-focused in that both the job seeker user and the talent seeker user can view both metrics, which are typically not visible to both types of users.

In embodiments, the requirements for the job opening are input by the talent seeker user when submitting or posting or otherwise generating the job opening, which is stored as part of job opening data by the system. The system may interact with the talent seeker user and guide the talent seeker user to input the requirements for the job opening.

Also, in embodiments, the personal criteria of a job seeker user can be input by a user and stored as part of user profile data of the job seeker user by the system. The system may interact with the job seeker user to guide the talent seeker user to input the user profile data (such as biographical information) which is used to build the job seeker user's profile. The personal criteria can include preferences that the job seeker user has related to employment. For example, personal preference criteria can include employment location, compensation, organizational size, and culture, as well as data derived by the system by processing or otherwise analyzing the user's profile data. For example, the system may ask personal questions to the user related to their likes and dislikes, which in turn, can be used to classify personality traits of the user. The personality traits of the user can then be used in comparing against personality traits for the job.

In embodiments, visual representations of ranking metrics are also displayed or otherwise provided to both job seeker users and talent seeker users. In one embodiment, the ranking metrics can include a first ranking metric, hereinafter referred to as a job qualification fitness ranking, which indicates a rank of the job seeker user among actual applicants for a job opening based on a comparison of the job qualification fitness metric for the job seeker user and all of the applicants for the job opening. In other embodiments, the job qualification fitness ranking can be calculated differently by including other users of the system in the ranking. For example, in embodiments, the job qualification fitness ranking can rank the job qualification fitness metric for a respective job seeker user against the job qualification fitness metrics of all users of the system that have answered screening questions for the job opening, but have not yet applied. In other embodiments, the job qualification fitness ranking can rank the job qualification fitness metric for a respective job seeker user against the job qualification fitness metrics for all other job seeker users of the system that have looked at the job opening but not completed the screening questions or applied. In other embodiments, the job qualification fitness ranking can rank the job qualification fitness metric for a respective job seeker user against the job qualification fitness metrics for all other job seeker users of the system that have expressed an interest in the job opening via user input. In other embodiments, the job qualification fitness ranking can rank the job qualification fitness metric for a respective job seeker user against the job qualification fitness metrics for all other job seeker users of the system who viewed the job opening. In other embodiments, the job qualification fitness ranking can rank the job qualification fitness metric for a respective job seeker user against the job qualification fitness metrics for all other job seeker users of the system.

The ranking metrics can also include a second ranking metric, hereinafter referred to as a job fitness metric ranking, which indicates how a respective job opening ranks against other job openings available to the job seeker user based on the job fitness metric for each job opening. Thus, all of the job openings available to the job seeker user can be ranked based on the personal preference or criteria of the talent seeker user, e.g., from best fit to worst fit.

In embodiments, the job qualification fitness metric and/or the job fitness metric can be based on a corresponding plurality of scored factors. The factors can be weighted and may have equal or different weights on the overall score (%). Example factors include a job seeker's current experience, skills, location, desired compensation, as well as cultural fit and aspirations. Each plurality of factors can be organized and visually displayed to a user of the system as a table or list of factors designed in such a way so that both the talent seeker or job seeker can easily understand in which factor any deficiencies in the fitness metrics lie. Thus, for example, if a job seeker user does not fully match the qualifications for a job opening, the job seeker user and the talent seeker user will know in which factor the job seeker user is deficient. From this information, the job seeker user will be able to take action to improve their qualifications in a targeted manner so that they can improve their matching metric for the job opening and increase their ranking among the other candidate job seeker users for the job opening. For example, if the job seeker user's deficiency lies in lacking skills for the job opening, the skills factor will display a measure of that deficiency and may also identify specific skills that the user is lacking. From this information, the job seeker user will be able to take action, such as enrolling in classes to learn the skill, to cure the deficiency in the skills factor, and improve the qualification fitness metric for the posted job opening.

Likewise, for example, if a job opening does not fully match the personal criteria of a job seeker user, both the job seeker user and talent seeker user will know in which area the job opening is deficient. From this information, the talent seeker user can take action to improve the job fitness metric for the job and increase the job fitness ranking among jobs available to the job seeker user. For example, if the deficiency of the job opening is that it is located in an area that is not preferred by the job seeker user, one action that the talent seeker user may take may be to change the job opening so that it is offered as a remote position.

Since the fitness metrics are based on factors that can be influenced by the actions of both job seeker users and talent seeker users, as well as other users, all of the fitness metrics and rankings are dynamic. For example, the rankings and fitness metrics can update automatically if the job seeker user or other applicants apply for the job opening, if other job openings become available, or if the underlying factors of the fitness metrics change (such as the personal criteria of the job seeker or the requirements for the job opening).

In embodiments, any user of the system can be both a job seeker and a talent seeker. Thus, a user looking for a job opening using the system can also post a job opening using the system (e.g., a contractor looking for a job opening who is also looking to hire subcontractors).

In embodiments, the job seeker and/or the talent seeker are not users of the system, but their information (e.g., job seeker profile, job posting) is imported or otherwise received from external data sources, such as third party databases to which the system can be granted access. Thus, other users of the system can access the job seeker and/or talent seeker data imported or otherwise received from the external data sources.

In yet other embodiments, the talent seeker user performs a search for candidate job seeker users having some degree of matching certain user profile data against job qualification criteria and job fitness criteria. For example, a talent seeker user may generate a search query for the system that includes job qualification criteria and personal job fitness criteria that can be input to the system. For each search, the system can return or otherwise output (e.g., visually in a display window) search results that include a plurality of candidate job seeker users that match at least some of the searched criteria. Thus, the plurality of candidate job seeker users have job qualifications that match (to at least some degree) the job qualifications the talent seeker is looking for and the listed candidate job seeker users match (to at least some degree) the criteria the talent seeker is looking for in a candidate. The matched candidate job seeker users may be ranked against one another based on the degree to which their profile data (e.g. qualifications or personal requirement) match those of the job criteria specified by the talent seeker user. Thus, the criteria queried by the talent seeker user are used as the factors by which each candidate job seeker user is quantitatively scored and ranked. For example, the job qualifications queried by the talent seeker user can be used to rank the matched candidate job seeker users based on fitness metrics calculated for the candidate job seeker users that are specific to the job opening.

Also in embodiments, the system can rank talent seeker searches for a particular candidate job seeker user. This ranking can be used as an indicator of how in-demand the candidate job seeker user is in the labor market. For example, a first talent seeker user (e.g., representing company A) and a second talent seeker user (e.g., representing company B) both conduct separate candidate searches that both identify the same particular candidate job seeker user as a match. Any user of the system, including the particular candidate job seeker user, can review the profile information of the particular candidate job seeker user to see that the particular candidate job seeker user was searched and matched to job openings of the first and second talent seeker users, although in some embodiments, the identity of the talent seeker users may be concealed. Nevertheless, the attributes of the two talent seeker users may be visible to a reviewer and can be used to rank the searches of the talent seeker users and, thereby, rank the talent seeker users.

For example, where the first talent seeker user (or the company represented by the first talent seeker user) is not in a field of interest to the particular candidate job seeker user, but the second talent seeker user (or the company represented by the second talent seeker user) is in a field of interest to the particular candidate job seeker user, the system can rank the first talent seeker's search lower than the second talent seeker's search since the particular candidate job seeker user is more marketable to the second talent seeker user (or the company represented by the second talent seeker user).

Other factors that can be used to rank the talent seeker user searches include the reputation of the talent seeker user (or the company represented by the talent seeker user). For example, search results from companies or talent seeker users with a lower reputation may be ranked lower than those companies or talent seeker users with a higher reputation.

Also, the search results of the talent seeker users (or companies represented by the talent seeker users may be ranked based on whether or not the employees of the talent seeker user (or company) are recognized in the areas of interest of the candidate job seeker user. For example, search results of a company having employees who are working in the areas of interest to the candidate job seeker user may be ranked higher than the search results of companies who do not have employees who are working in the areas of interest.

Also, the search results of talent seeker users (or companies represented by the talent seeker users) may be ranked based on how closely connected the talent seeker user (and its employees) are to the contacts of the candidate job seeker user. For example, if the talent seeker user (or company it represents) and its employees are closely connected to people the candidate job seeker user knows, then that talent seeker's search may be ranked more highly than the search of another talent seeker user (or company it represents) who's employees are not closely connected to people the candidate job seeker user knows.

Other factors that may be used to rank the searches of talent seeker users (or companies represented by talent seeker users) are the compatibility of the required skills and experience with the skills and experience of the candidate job seeker user. For example, if the search criteria require a much higher level of skills than those possessed by the candidate job seeker user, then the search can be ranked lower than another search that requires skills more closely matching the skills possessed by the candidate job seeker user. Thus, searches by talent seeker users (or companies) for whom the candidate job seeker user is less qualified can be ranked lower, indicating there will be less competition for the candidate job seeker user with the talent seeker user (or company) who conducted the lower ranked search. By way of example, one skill that may be a requirement in the job criteria specified in a talent seeker search is a required language. For example, if a talent seeker's search criteria includes a language requirement, the search can be ranked based on the compatibility with the language skills of the candidate job seeker user. Thus, searches requiring a language that the candidate job seeker user does not speak will be ranked lower than searches that do not require that language. On the other hand, if the candidate job seeker user lacks skills (e.g., language skills) or experience required for the job, but has development interests (e.g., aspirations for learning the skills or gaining experience), the search may be ranked higher than if the candidate job seeker user had no development interests, since the candidate job seeker user has an interest in developing skills and growing into a position requiring the missing skills.

Another factor that may be considered in ranking the searches of talent seeker users is matching the compensation expectations of the job opening and the candidate job seeker user. For example, searches that include compensation criteria for the job opening (e.g., salary range) that more closely match the compensation expectations of the candidate job seeker user may be ranked higher than searches with compensation criteria that are further from compensation expectations of the candidate job seeker user.

Another factor that may be considered in ranking the searches of talent seekers is geographical proximity of the candidate job seeker user to the talent seeker user (or company). For example, in embodiments, the closer a talent seeker user is geographically to the candidate job seeker user, the higher the talent seeker user's search will be ranked. This can reflect a greater desire of the candidate job seeker user to be located closer to an existing geographical location. Of course, if a candidate job seeker user has expressed interest in working in a specific geographical area different from his or her existing location, the rankings can be adjusted based on the proximity to the specific area.

Other factors that may be considered in ranking the searches of talent seeker users relate to professional culture. For example, one factor that may be used for ranking searches of talent seeker users is how compatible the candidate job seeker user's professional culture is with the professional culture of the leader of the talent seeker user (or company represented by the talent seeker user). Another factor that may be used for ranking searches of talent seeker users is how compatible the candidate job seeker user's professional culture is with the professional culture of employees of the talent seeker user (or company represented by the talent seeker user). Yet another factor that may be used for ranking searches of talent seeker users is how compatible the candidate job seeker user's professional culture is with the professional culture of the organization of the talent seeker user (or company represented by the talent seeker user). For example, the greater the compatibility between the candidate job seeker user's professional culture and that of the leader, employees, or organization, the higher the ranking of the search.

Another factor that may be considered in ranking the searches of the talent seeker users is the size of the company (e.g., number of employees) and whether the size is of interest to the candidate job seeker user. For example, if the talent seeker user represents a company that has a number of employees exceeding a range desired by the candidate job seeker user (i.e., the organization size is not a good fit because it is too big for the candidate), then the search for the talent seeker user may be ranked lower than another search of another talent seeker user representing another company that has a number of employees within the range desired by the candidate job seeker user.

Yet another factor that may be considered in ranking the searches of the talent seeker users is whether the search criteria includes all or part of the information the candidate job seeker user is looking for or considering in their employment. For example, the candidate job seeker user can consider more criteria in their employment than the criteria used in a search by a first talent seeker user. On the other hand, a search by a second talent seeker user may have included criteria that the candidate job seeker user considers important in his or her employment. Thus, in that case, the candidate job seeker user may be more likely to consider employment with the second talent seeker user than the first talent seeker user. Accordingly, the search of the second talent seeker user can be ranked higher than the search of the first talent seeker user.

In accordance with other aspects, metrics and rankings can be displayed and dynamically updated on the display windows generated by the system while users interact with the system. Thus, in addition to a job seeker user being able to view their fitness metrics and rankings while viewing a specific job opening, the system can display fitness metric and ranking information (although the numerical measurements dynamically change) even when the user moves between other screens and displays of the system.

For example, in embodiments, the system can be configured to permit a first user (who can be a job seeker user or talent seeker user or both) to search for any other users of the system and view user profile information for the other users in conjunction with viewing fitness metrics of the other users. Specifically, if the first user is viewing profile information of a second user, the first user will be able to see how well the first user (as a job seeker user) matches and ranks for job openings posted by the second user, or the first user can see how the second user would match and rank for job openings of interest posted by the first user (as a talent seeker user). Metrics and rankings of the other job seeker users can be displayed with the user profile information.

The fitness metric information viewable from the second user's profile information can be used by the first user in various ways. For example, the system may display the second user's fitness metrics for a job opening posted by the first user (as a talent seeker user). From this information, the first user may invite the second user to apply for the job opening or possibly update the job description of the job opening to provide a better matching of candidate users to the job opening.

In other aspects, parts or all of the methods as described and claimed in the present disclosure can be embodied in a machine or computer readable storage medium including instructed, which when executed on the machine or computer, cause the machine or computer to carry out such method steps.

This summary is intended to provide an overview of subject matter of the present disclosure. It is not intended to provide an exclusive or exhaustive explanation of the inventions described herein. The detailed description is included to provide further information about the present disclosure.

### BRIEF DESCRIPTION OF THE DRAWINGS

FIG. 1A is a schematic illustration of an example job matching system.

FIG. 1B is a flowchart of a workflow of interactions between the system of FIG. 1A and one or talent seeker users and one or more job seeker users.

FIG. 2A1 is a flowchart showing exemplary details of interaction between a job seeker user and the system.

FIG. 2A2 is a flowchart of exemplary details of process A of the workflow shown in FIG. 2A1.

FIG. 2A3 is a flowchart of exemplary details of process B of the workflow shown in FIG. 2A1.

FIG. 2A4 is a flowchart of exemplary details of process C of the workflow shown in FIG. 2A1.

FIG. 2B is a flowchart showing exemplary details of interaction between a talent seeker user and the system.

FIG. 3 is a display window that is displayed upon login to the system shown in FIG. 1A.

FIG. 4A shows the display window of FIG. 3 updated after a job seeker user job search query.

FIG. 4B shows visual representations of tachometers used to indicate score levels for fitness metrics and detailed factor scores.

FIG. 4C shows the display window of FIG. 4A updated after a job seeker user selects the Match and Rank tab of FIG. 4A to show a detailed analysis of the fitness metrics with underlying detailed factor scores.

FIG. 4D shows the display of FIG. 4C updated after a job seeker user selects one of the listed factors in FIG. 4C.

FIG. 4E shows the display window of FIG. 3 updated after a job seeker user job search query where the job seeker user has not input user profile information.

FIG. 4F shows the display window of FIG. 4E updated after a job seeker user selects the Match and Rank tab in FIG. 4E to show that the system dynamically updates fitness metrics as the job seeker user inputs more information to the system.

FIGS. 5A and 5B show a display window generated by the system that depicts profile information for a selected user of the system.

FIG. 6A shows a display window generated by the system for presentation to a talent seeker user, which depicts a Kanban chart for a particular job opening (e.g., with label “Senior Full-stack Engineer”).

FIG. 6B shows the display window of FIG. 6A updated after a talent seeker user selects one of the candidate job seeker users in the Kanban chart of FIG. 6A to show profile information about the selected candidate job seeker user.

FIG. 6C shows the display window of FIG. 6B updated after a talent seeker user selects the Match and Rank tab in FIG. 6B to show details of the fitness metrics for the selected candidate job seeker user.

FIG. 6D shows an alternate display of the selected candidate job seeker user's information in the Kanban chart in FIG. 6A to show that the candidate job seeker user is disqualified.

FIG. 6E shows an alternate display window to that of FIG. 6C where additional indicators are provided to show the candidate job seeker user is disqualified for the job opening.

FIG. 7A shows a display window generated by the system for presentation to a job seeker user, which depicts the fitness metrics and rankings of the job seeker user for a particular job opening (e.g., labeled “Product Design Lead”). The display window also presets detailed factors and scores used to determine the fitness metrics and rankings of the given job seeker user for the particular job opening.

FIG. 7B shows another display window generated by the system for presentation to a job seeker user, which is similar to the display window of FIG. 7A but includes one or more visual indications (e.g., red “X” indicators) that efficiently convey that the job seeker user is disqualified from the particular job opening.

FIG. 7C shown another display window generated by the system for presentation to a job seeker user, which allows the job seeker to review the fitness ranking of the job seeker user for a particular job opening along with the rankings, usernames, current job title, fitness scores (e.g., tachometers), and “Reviewed” status for other applicants of the particular job opening.

FIG. 7D shows yet another display window generated by the system for presentation to a job seeker user, which is similar to the display window of FIG. 7C but permits the job seeker user to view information that summarizes the reason for disqualification of a respective job seeker user for the particular job opening.

FIG. 7E shows another display window presented to a job seeker user that depicts the fitness ranking of the job seeker user for a particular job opening after the job seeker user has applied for the particular job opening.

FIG. 8 is a schematic diagram of an example computer system.

### DETAILED DESCRIPTION OF THE PREFERRED EMBODIMENTS

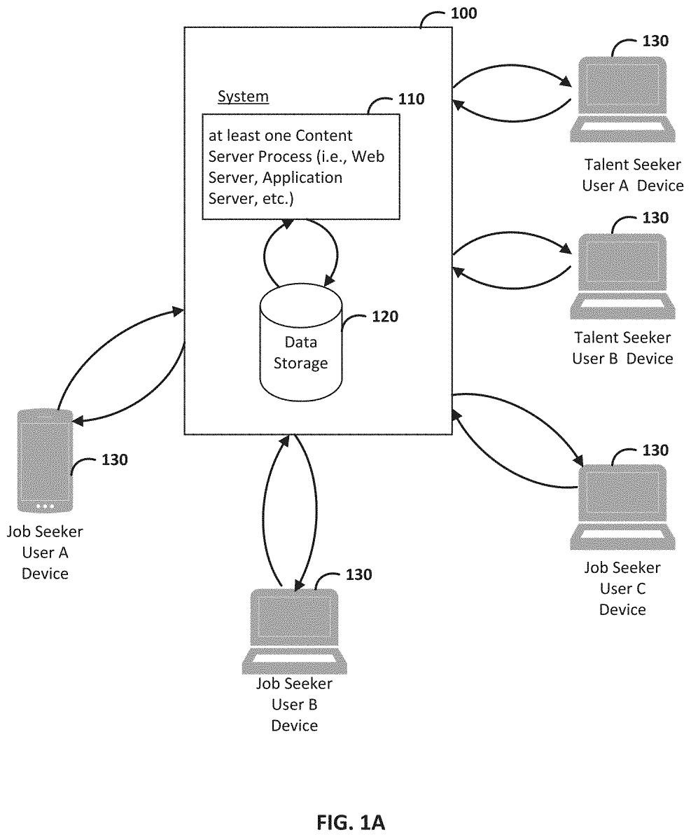

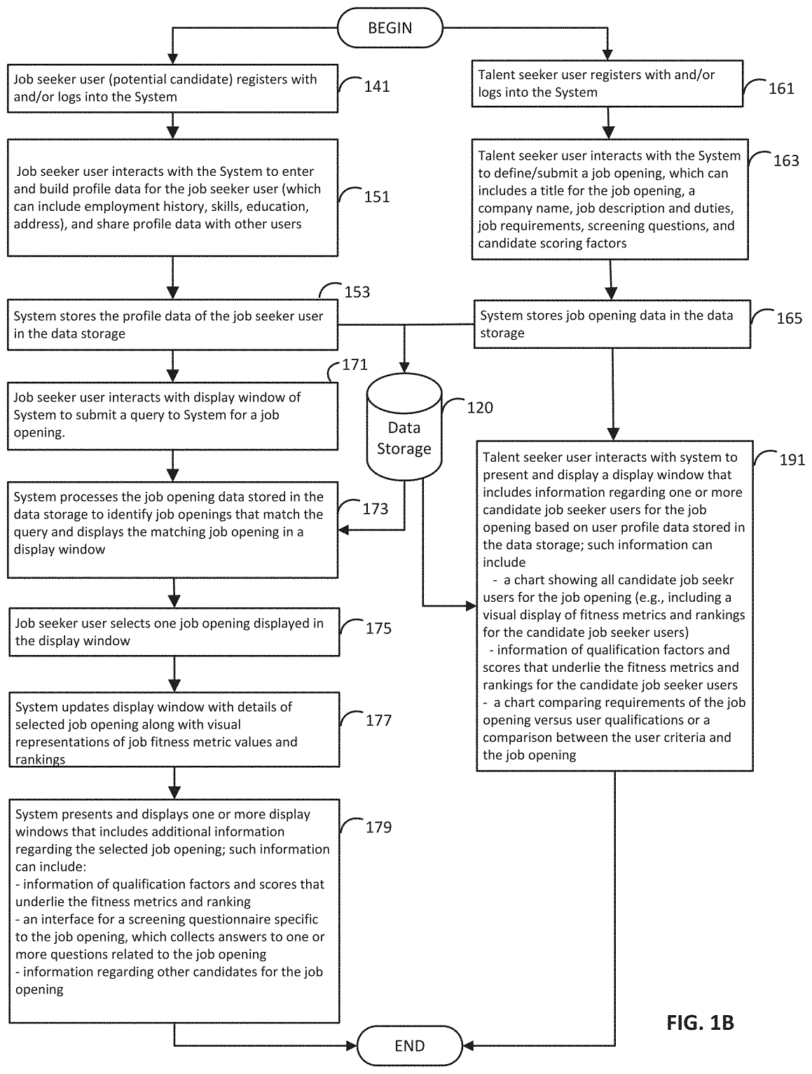

FIG. 1A shows an example job matching system 100 according to one example of the current disclosure. The system 100 may contain a content server 110. Content server 110 may communicate with a data storage 120 and computer systems 130 of users through a network. Content server 110 may be responsible for the retrieval, presentation, and maintenance of registered user profile information stored in data storage 120 and interaction with the users as described herein. Content server 110 in one example may include or be an application server or web server that fetches or dynamically creates internet web pages or other content (which may include portions of, or all of, profile information for a register user) in response to requests or input provided by users using computer systems 130. The data storage 120 in one example can be provided by a database system, a distributed data storage system, a decentralized network data storage system (such as a distributed ledger or blockchain), or some other suitable form of data storage.

Users of the system 100 may act as job seeker users and/or talent seeker users. For example, users acting as a job seeker can include individuals, agents acting on behalf of one or more individuals, and organizational user. Also, users acting as talent seekers may include individuals, employers, recruiters, potential employers or recruiters, and agents acting on behalf of such employers or recruiters, or on behalf of some other interested parties. In some cases, the same user can act as both a talent seeker and a job seeker. For example, an individual user of the system 100 may be acting as a contractor looking for a job, while also be looking for other users to subcontract parts of the job. Thus, the contractor user in the example can be both a job seeker and a talent seeker.

Users access the system 100 using respective computer devices or systems 130 through a network. The network may be any means of enabling the system 100 to communicate data with a computer system 130 remotely, such as the internet, an extranet, a LAN, WAN, wireless, wired, or the like, or any combination. For example, the computer device or systems 130 employed by two exemplary talent seeker users are labeled Talent Seeker User A device and Talent Seeker User B device; and the computer device or systems 130 employed by three exemplary job seeker users are labeled Job Seeker User A device, Job Seeker User B device and Job Seeker User C device. The computer device or systems 130 can be any one of a number of different types of computer systems, including PCs, workstations, notebooks, tablets, smartphones, other mobile devices, and other data communication enabled computing devices.

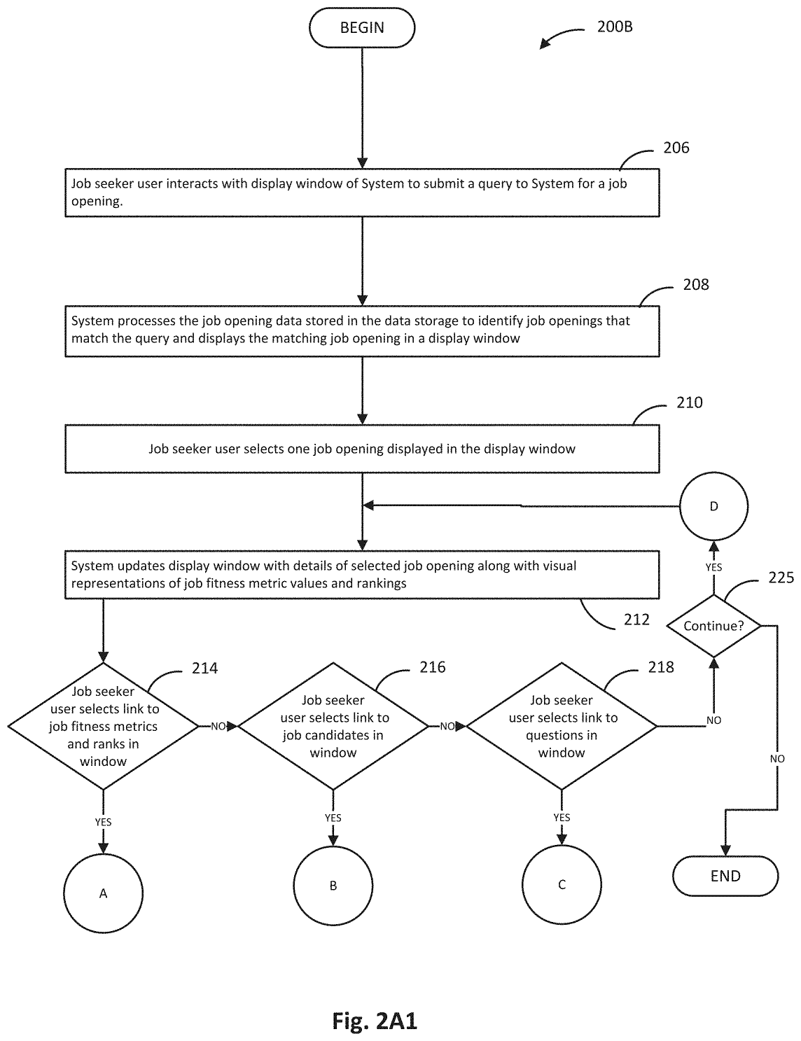

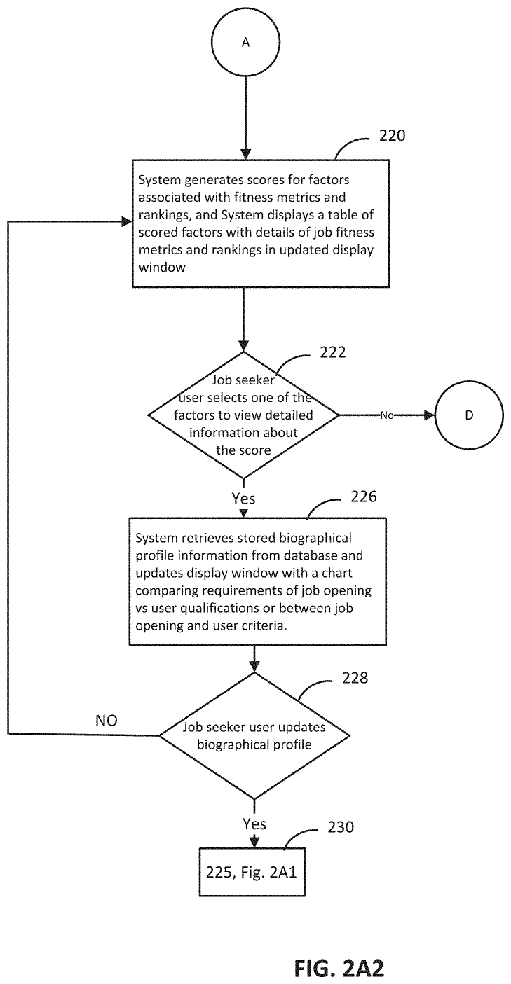

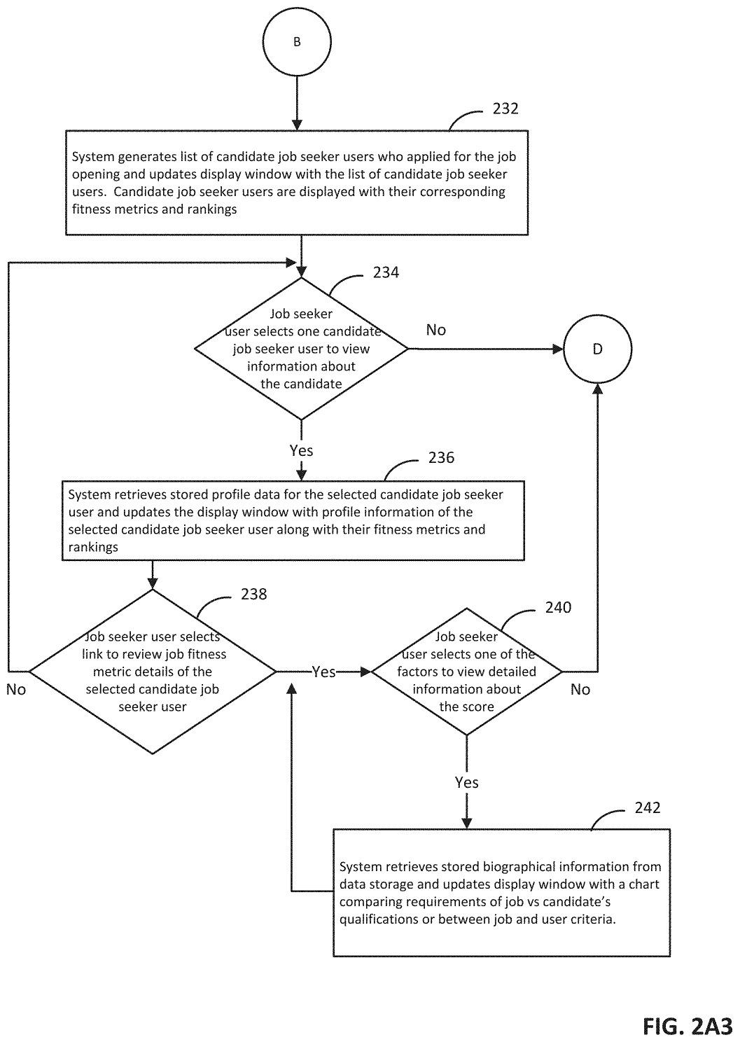

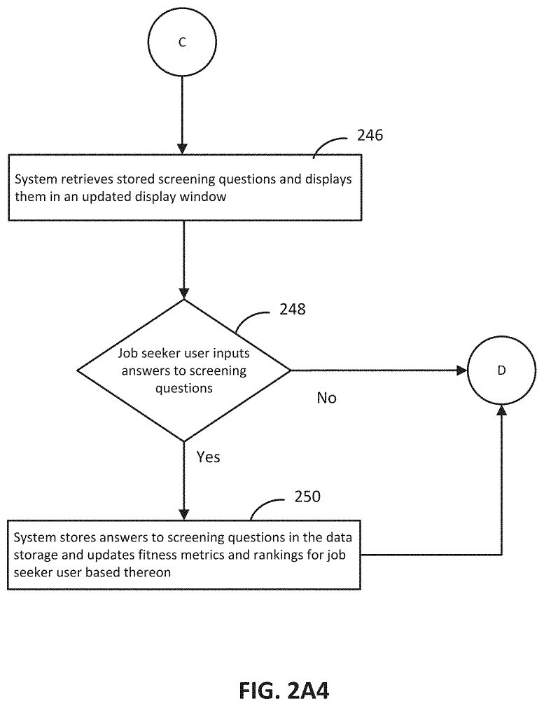

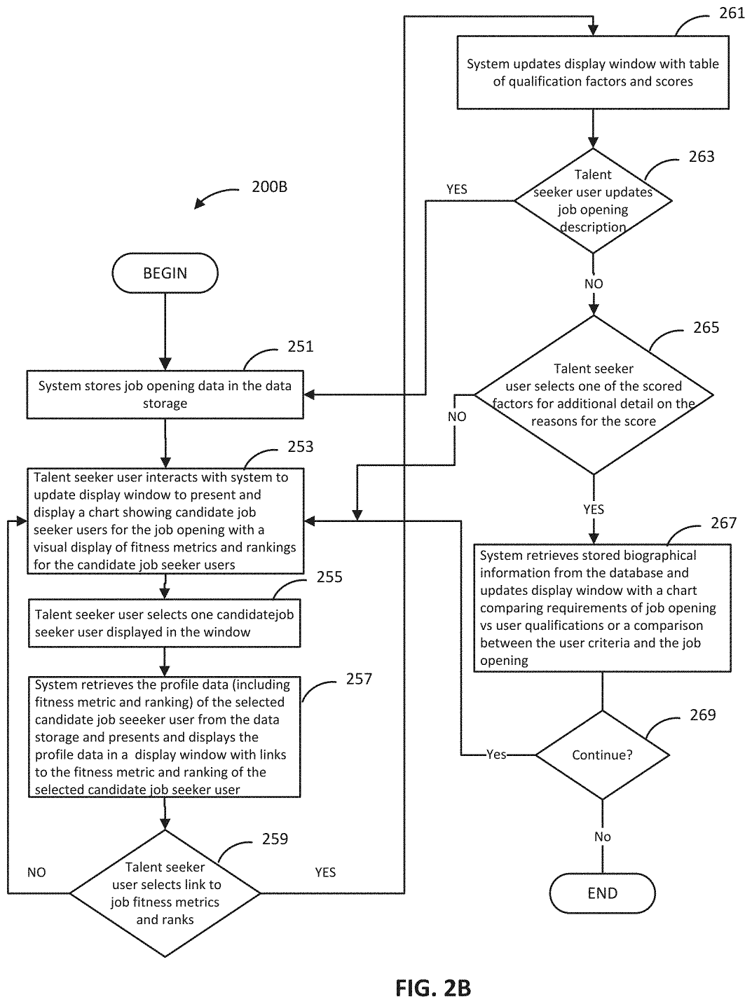

The system 100 can be used to carry out workflows for matching job seeker users with talent seeker users as described more fully herein and shown in FIGS. 1B to 2B. FIGS. 2A1 to 2A4 show additional details of a sub-process 200A between a job seeker user and the system 100. FIG. 2B shows additional details of a sub-process 200B between a talent seeker user and the system 100. Interactions between the system 100 and any user of the system 100 can take place via data communication over the communication network between the system 100 and the computer systems 130 used by the users of the system 100. Such interactions can employ display windows that are generated by the system (e.g., content server 110) and presented to the users via data communication over the communication network between the system 100 and the computer systems 130 and for display on a display device of such computer systems 130.

FIG. 1B is a flowchart of a workflow of interactions between the system of FIG. 1A and a talent seeker user and a job seeker user. In FIG. 1B, interactions between the system 100 and the job seeker user are shown on the left side while interactions between the system and the talent seeker users are shown on the right side.

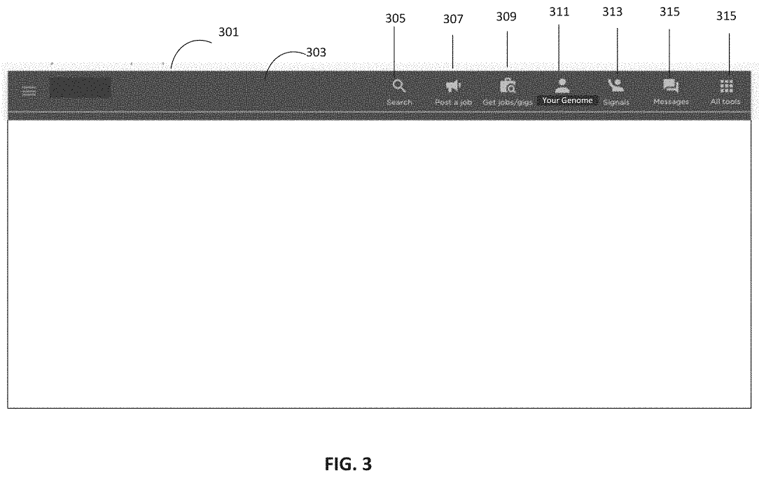

At block 141 a job seeker user, who is a potential candidate for one or more job openings maintained by the system, registers with and/or logs into the system 100. The job seeker user can be a potential candidate for a particular job opening where the job seeker user who has not yet applied for the particular job opening but may do so in the future. In response to logging into the system 100, the system displays a graphical display window, such as the window 301 shown in FIG. 3. The window 301 can be used by the job seeker user to interact with the system 100.

At block 151, the job seeker user interacts with the system 100 using the window 301 to input profile information (such as biographical information), which is used by the system for building profile data of the job seeker user. The profile data is maintained by the system and can be accessed to share profile data with other users as well as used calculating fitness metrics, discussed in greater detail below. For example, the user can select the “your genome” tool 311 from the toolbar 303 in FIG. 3, which causes the system to prompt the user to input or update the user profile data maintained by the system 100. The user profile data can be accessed by the system 100 and used in scoring the detailed factors which are inputs to calculating the aforementioned fitness metrics.

In embodiments, the user profile data may include work history, job skills, and educational background. Also, the user profile data may include personal preference criteria related to employment. For example, personal criteria can include preferred employment geographical location (e.g., city, state, country), preferred company employee size, salary, or other compensation requirements. In addition to direct input of information by the user, the system 100 may prompt the user to answer personal questions about the user's preferences, which, in turn, can be used by the system to build at least part of the user's profile data.

The user profile data can also be used by the system 100 to derive additional profile information about the user. For example, in embodiments, the system 100 is configured to use information from the user profile data to classify the personality traits of the user according to known models of behavior, such as a HEXACO model. Also, the system may use the profile data to derive professional dynamics scores based on an OCP instrument. Such system-derived user profile data can be used by the system in calculating the aforementioned fitness metrics.

At block 153, the system stores the user profile data of the job seeker user in the data storage 120. Additional details of the interaction of the job seeker user with the system to identify matching job opening is described below with respect to blocks 171 to 179.

The talent seeker's interaction with the system begins at block 161 where a talent seeker user registers with and/or logs into the system and is also presented with a graphical display window that can be used to interact with the system 100. For example, the talent seeker user can be presented with the window 301 shown in FIG. 3. The talent seeker user can select the “post a job” tool 307 from the toolbar 303, which causes the system 100 to display a job opening input interface (not shown) that the first user uses to input information about the job opening.

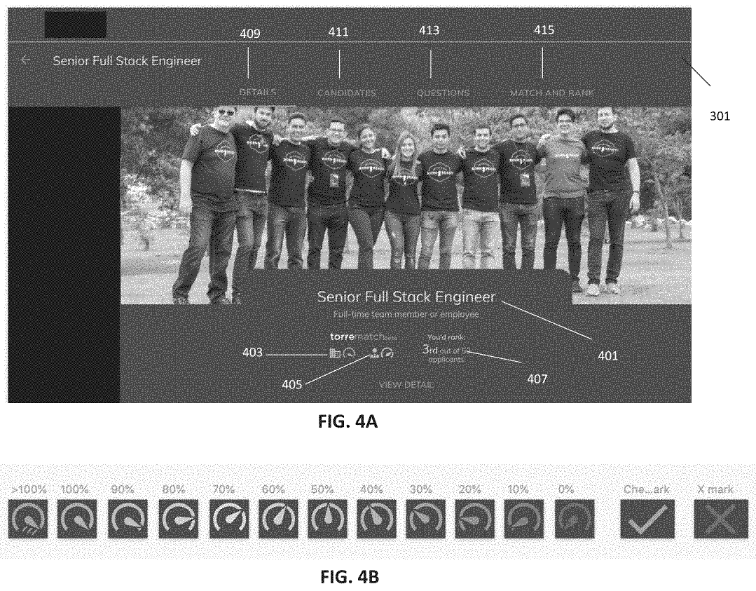

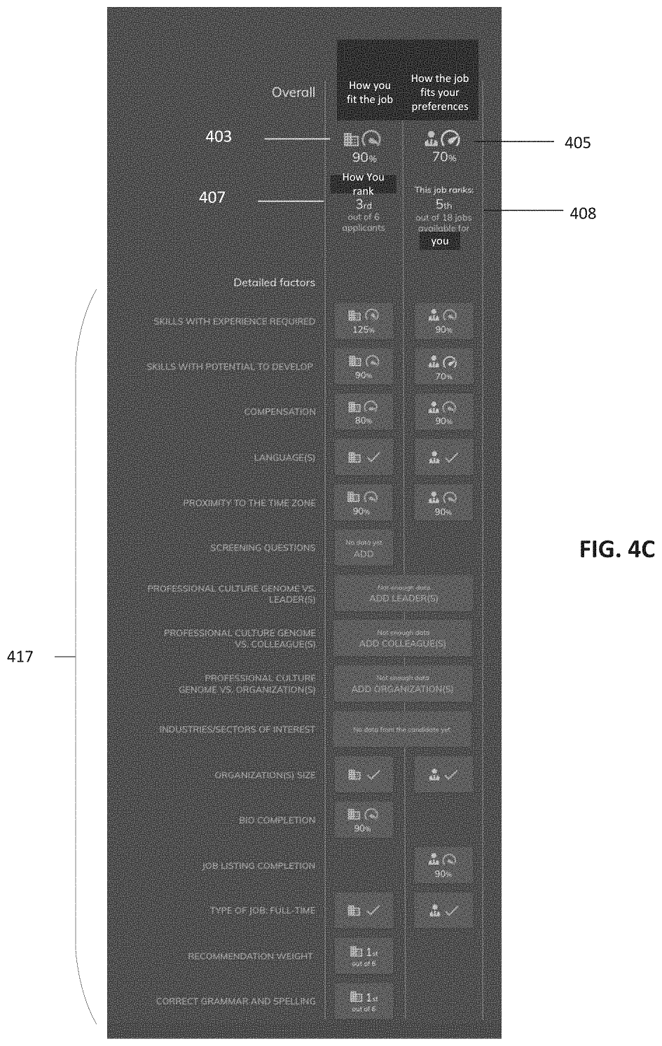

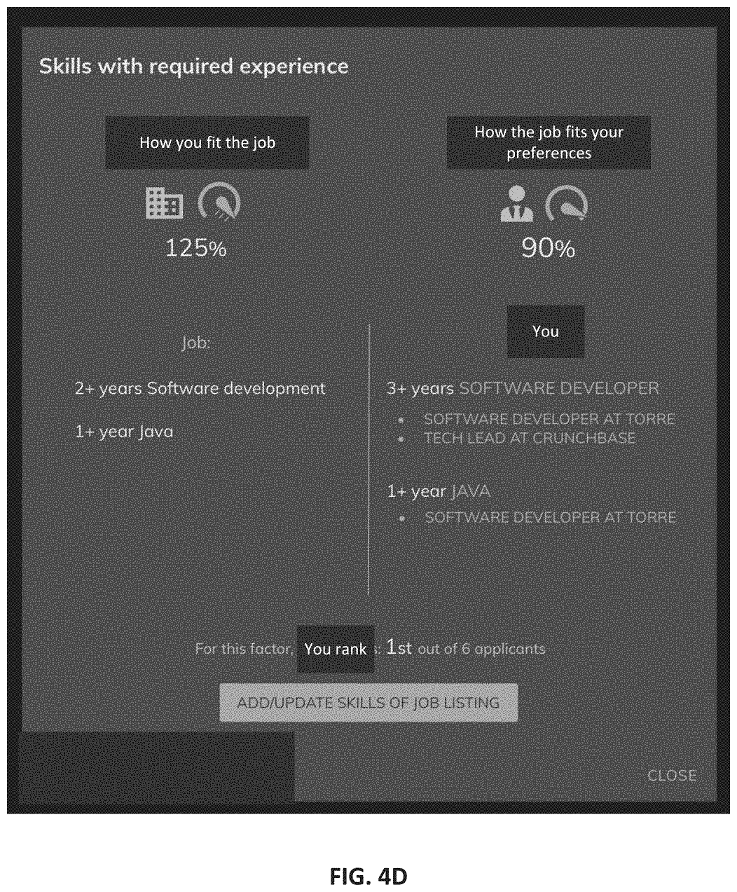

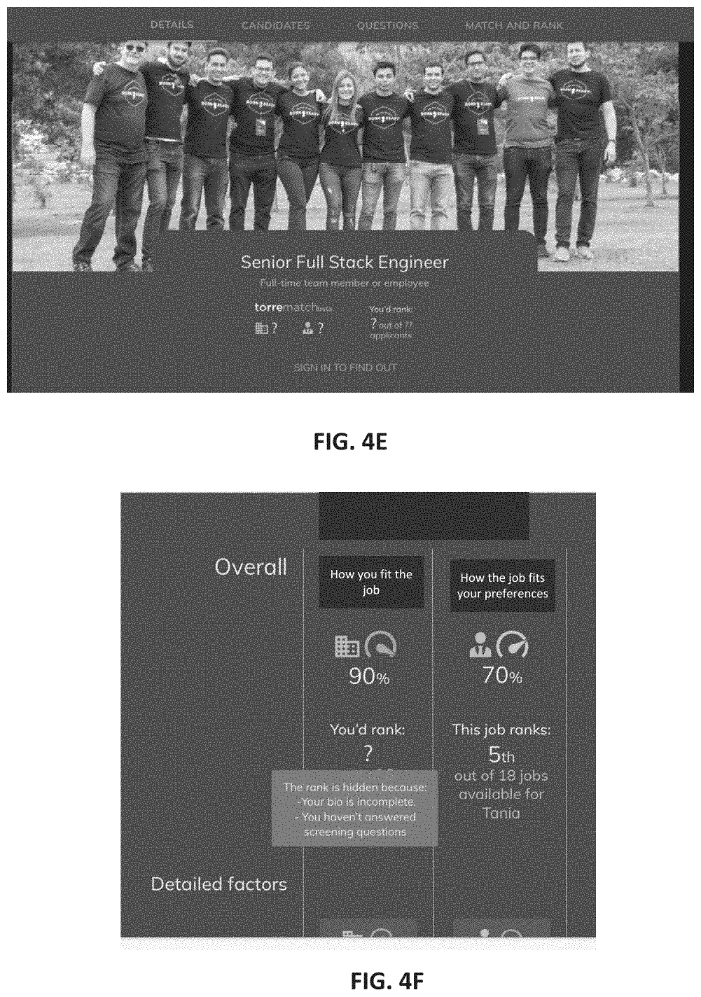

At block 163, the talent seeker user interacts with the system 100 using the display window to define/submit a job opening, which can include a title for the job opening, a company name, job description and duties, job requirements, screening questions, and scoring factors. Screening questions are used to elicit a binary (e.g., yes/no) response from the job seeker user. For screening questions, positive answers to the questions can be indicated with a green check mark, while negative answers to the questions can be indicated with a red “X”, as shown in FIG. 4B. If the screening questions are qualification questions, they may override any other scored factor used for calculating the fitness metrics. For example, if a job seeker is not legally permitted to work, they are disqualified for the job regardless of any other scores of any factors.

At block 165 the system stores the job opening data in the data storage 120.

The operations of blocks 161 to 165 can be performed independently by multiple talent seeker users to permit the multiple talent seeker users to submit multiple job openings that are maintained by the system. Similarly, the operations of blocks 161 to 165 can be repeated by the same talent seeker user to permit the talent seeker user to submit multiple job openings that are maintained by the system. These job openings are matched to particular job seeker users in the operations of blocks 171 to 179 as described below.

At block 171, the job seeker user interacts with the display window of the system to submit a query to the system for a job opening.

At block 173, the system processes the job opening data stored in the data storage to identify job openings that match the query and displays the matching job opening in the display window. For example, details of exemplary job querying are described in US Pat. Pub. No. 2019/0236065 (Torrenegra et al.), the content of which is herein incorporated by reference in its entirety.

At block 175, the job seeker user selects one job opening displayed in the display window.

At block 177, the system updates the display window with details of the selected job opening along with visual representations of the job fitness metric values and rankings of the job seeker user that pertains to the selected job opening.

At block 179, the system 100 displays one or more display window that includes additional information regarding the selected job opening. In embodiments, the information can include information of qualification factors and scores that underlie the fitness metrics and rankings; an interface for a screening questionnaire specific to the job opening, which collects answers to one or more questions related to the job opening; and information regarding other candidate job seeker users for the job opening who have already applied for the job opening.

Note that the operations of blocks 171 to 179 can performed be independently by multiple job seeker users to permit the multiple job seeker users to match job openings maintained by the system. Similarly, the operations of blocks 171 to 179 can be repeated by the same job seeker to permit the job seeker user to investigate matching to multiple job openings that are maintained by the system.

The talent seeker users can also interact with the system to view information regarding one or more candidate job seeker users for a job opening that the talent seeker user has posted based on user profile data stored in the data storage. Particularly, at block 191, the talent seeker user can interact with system to present and display a display window that includes information regarding one or more candidate job seeker users or the job opening based on user profile data stored in the data storage. In embodiments, such information can include a chart showing all candidate job seeker users or the job opening (e.g., including a visual display of fitness metrics and rankings for the candidate job seeker users); information of qualification factors and scores that underlie the fitness metrics and rankings for the candidate job seeker users; and a chart comparing requirements of the job opening versus user qualifications or a comparison between the user criteria and the job opening.

FIGS. 2A1 to 2A4 shows exemplary details of the interaction or workflow 200A between the job seeker user and the system as part of blocks 171-179 of FIG. 1B. FIG. 2B shows exemplary details of the interaction or workflow 200B between the talent seeker user and system as part of block 191 of FIG. 1B.

Turing to the workflow 200A of FIGS. 2A1 to 2A4, at block 206, the job seeker user interacts with the system 100 to submit a query to search for a job opening. A user who wishes to interact with the system 100 to search for a job (or to search for another user of the system 100) at block 206 of workflow 200 can select the “search” tool 305 from the toolbar 303 (FIG. 3), which causes the system 100 to present the user with a search query interface.

At block 208, the system 100 processes the query and job opening data stored in the data storage to identify job openings that match the query and displays the matching job openings in the display window 301. At block 210, the job seeker user interacts with the system 100 by selecting one job opening to view, which causes the system to update the display window 301 at block 212 with details of the selected job opening along with a job qualification fitness metric and a job fitness metric for the user that have been calculated by the system 100. The system 100 may also display one or more of a job qualification fitness ranking and a job fitness ranking for the job seeker user. Further details of the fitness metrics and rankings are provided below.

The job qualification fitness metric is a measure of how well a job seeker user's qualifications match the requirements of a particular job opening posted by the talent seeker user. The job fitness metric is a measure of how well the aspects of the job opening match personal criteria or preferences of the talent seeker. The requirements and aspects of the job are determined by the talent seeker user when inputting the job opening into the system 100. The personal criteria are derived from the user's profile data.

FIG. 4A shows the window 301 of FIG. 3 updated based on a job seeker user searching for a job opening by selecting the “search” tool 305 from the toolbar 303. In the example, the job seeker user has submitted a search query to the system for a job opening and the system 100 has returned a search result that includes a job opening entitled “Senior Full Stack Engineer”. In addition to the title, the system 100 displays an image related to the job or organization, along with respective icons representing the job qualification fitness metric 403 and the job fitness metric 405, and may also display a job qualification fitness ranking 407 (as shown) and/or a job fitness ranking 408 (shown in FIG. 4B), discussed in greater detail below.

To help talent seekers and job seekers save time and make informed decisions, the system 100 provides users with a visual display of the fitness metrics 403 and 405, which are displayed together in a unitary display window with two different icons. In FIG. 4A, the job qualification fitness metric 403 is represented by a building icon, and the job fitness metric 405 is represented by a necktie icon. Next to each of the icons is a measurement indicator, such as gauges with dials shown in FIG. 4B. The relative position of the dials of the gauges indicate the measurement value (e.g., on scale of 0 to 100%) of the respective fitness metric. Thus, in FIG. 4A, the job qualification fitness metric has a measurement value of 90%, while the job fitness metric has a measurement of 70%.

The job qualification fitness metric 403 and job fitness metric 405 are each associated with a plurality of factors. Some of these factors can be scored and possibly weighted to calculate the respective fitness metrics. The qualification fitness metric, job fitness metric, and scored factors can be represented as percentages, e.g., 0% representing no match, 100% representing a full match, and over 100% representing there are factors where the match exceeds either the requirements of the job or the criteria of the job seeker. FIG. 4B is a table that correlates the gauge icons with numerical percentage values. The gauges can be color coded for easier comprehension. For example, colors of the gauges can be shades of green above 50% with increasing brightness for higher percentages and shades of red below 50% with increasing brightness for lower percentages. Also, the qualification fitness metric, job fitness metric, and scored factors can be represented by binary indicators, such as a check mark or an “X”, as shown in FIG. 4B.

In FIG. 4A, a job qualification ranking 407 is also displayed with the fitness metrics 403 and 405. The job qualification ranking 407 ranks the job seeker user among other users of the system who have actually applied for the job based on a comparison of each user's (the job seeker user and the other applicant users) qualification fitness metrics for the job. In the example, the user has a rank of three (3) out of fifty (50) applicants. Thus, the user's job qualification metric is the third highest out of fifty applicants.

In other embodiments, the job qualification fitness ranking can be calculated differently by including other users of the system in the job qualification fitness ranking. For example, in embodiments, the job qualification fitness ranking can rank the job qualification fitness metric for a respective job seeker user against the job qualification fitness metrics of all users of the system that have answered screening questions for the job opening, but have not yet applied. In other embodiments, the job qualification fitness ranking can rank the job qualification fitness metric for a respective job seeker user against the job qualification fitness metrics for all other job seeker users of the system that have looked at the job opening, but have not completed the screening questions or applied. In other embodiments, the job qualification fitness ranking can rank the job qualification fitness metric for a respective job seeker user against the job qualification fitness metrics for all other job seeker users of the system that have expressed an interest in the job opening via user input. In other embodiments, the job qualification fitness ranking can rank the job qualification fitness metric for a respective job seeker user against the job qualification fitness metrics for all other job seeker users of the system who viewed the job opening. In other embodiments, the job qualification fitness ranking can rank the job qualification fitness metric for a respective job seeker user against the job qualification fitness metrics for all other job seeker users of the system.

Although not shown in FIG. 4A, the system 100 also calculates a job fitness ranking 408, which is displayed in FIG. 4C, discussed below. The job fitness ranking 408 ranks the job opening against all other job openings that are available to the job seeker user based on a comparison of job fitness metrics for all of those job openings. In this example shown in FIG. 4C, the job opening that the job seeker user is reviewing ranks fifth out of a total of eighteen (18) job openings available to the job seeker user. This means that at least four other available jobs have higher job fitness metrics than the one the job seeker user is investigating, and, therefore, there are other jobs available that would fit the job seeker user's personal criteria better than the one the job seeker user is currently investigating.

Turning back to FIG. 4A, above the image in the window 301 in FIG. 4A are four tabs that the job seeker user can select to change the image presented in the window 301 and obtain additional information about the posted job opening. The tabs are entitled “Details” 409, “Candidates” 411, “Questions” 413, and “Match and Rank” 415. FIG. 4A shows the window 301 when “Details” tab 409 is selected.

Turning back to the workflow 200A of FIG. 2A1, at block 214, in the event that the job seeker user wishes to see additional details of the scores underlying the fitness metrics 403, 405, the job seeker user can select the “Match and Rank” tab 415, which in turn causes the system to enter the process “A” in FIG. 2A2. Specifically, at block 220, the system generates or otherwise obtains scores for the factors associated with the fitness metrics 403 and 405 and rankings 407 and 408 and updates the window 301 to display the table shown in FIG. 4C.

In FIG. 4C the job qualification fitness metric 403 and the job fitness metric 405 are shown as headings of respective columns of scores of detailed factors 417 listed in the table. The job qualification fitness metric 403 is associated with the label “How you fit the job” in the middle column of the table, whereas the job fitness metric 405 is associated with the label “How the job fits your preferences” in the right column of the table. The tabular organization and presentation of the factors 417 and scores is designed so that the job seeker user can easily understand in which factor any deficiency in the fitness metrics lies.

The factors can be weighed equally or unequally for calculating the overall value of the fitness metrics. Example factors include a job seeker's current experience, skills, location, desired compensation, as well as cultural fit and aspirations. Some of the detailed factors apply to both fitness metrics 403, 405, while some factors (e.g., screening questions) only apply to one of the two fitness metrics, i.e., to the job qualification metric 403. Some detailed factors are not scored due to a lack of information in either the job seeker user's profile data or due to a lack of information input by the talent seeker user when setting up the job opening. When the factors are not scored due to lack of information, the system 100 can automatically adjust the weights of the remaining factors more heavily to arrive at a fitness metric value.

If a job seeker user does not fully match the qualifications for a job opening (i.e., the job qualification metric is less than 100%), the display in FIG. 4C can be useful for a job seeker user to understand in which factor the job seeker user's qualifications are deficient. At block 222, a job seeker user can select one of the factors to view detailed information about the factor score. At block 226, the system retrieves stored user profile data from the database and updates the display window 301 with a chart, such as is shown in FIG. 4D, comparing job requirements with user qualifications. Alternatively, the job seeker user can select a score for a factor related to job fitness metric which will show a comparison between the job seeker user's job preference criteria and the job opening.

From the information shown in FIG. 4D, the job seeker user will be able to take action to improve their qualifications in a targeted manner so that the job seeker user can improve his/her fitness metrics for the job opening and increase their ranking among candidate job seeker users for the job opening. For example, if the job seeker user's deficiency lies in lacking skills for the job opening, the skills factor will display an indicator of that deficiency. From this information, the job seeker user will be able to take action, such as enrolling in classes to learn the skill, to cure the deficiency in the skills factor, and improve the qualification fitness metric for the posted job opening. Also, if the information listed in the table in FIG. 4D is incorrect, a job seeker user can select the button to update the data stored in the database, such as user profile data. If the job seeker user updates his or her user profile data in block 228, the workflow 200A will return to block 225 in FIG. 2A1 (block 230).

Turning back to the workflow 200A of the FIG. 2A1, a job seeker user of system 100 may also interact with the system to view information about other candidate job seeker users for the job opening who have already applied. At block 216 of the workflow 200A, the job seeker user can select a link from the window displayed at block 212 to begin process “B”, shown in FIG. 2A3. As shown in FIG. 2A3, upon making the selection at block 216, the system generates a list of candidate job seeker users who applied for the job opening and updates the display window 301 with the list of candidate job seeker users which are displayed with their corresponding fitness metrics and rankings in block 232.

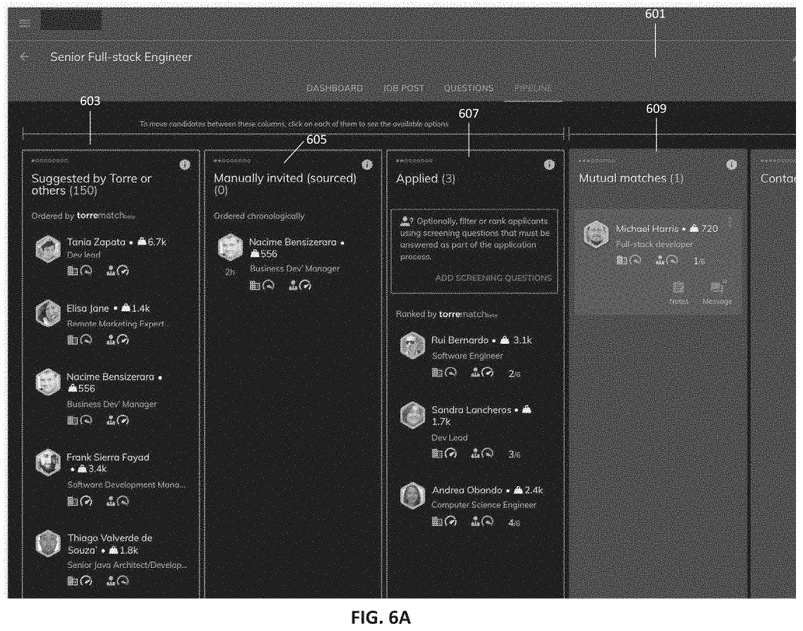

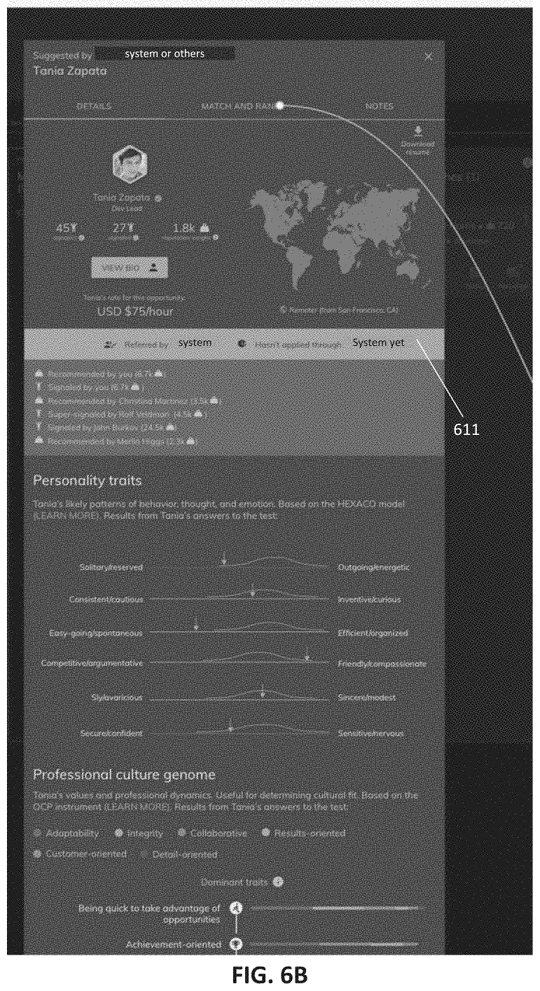

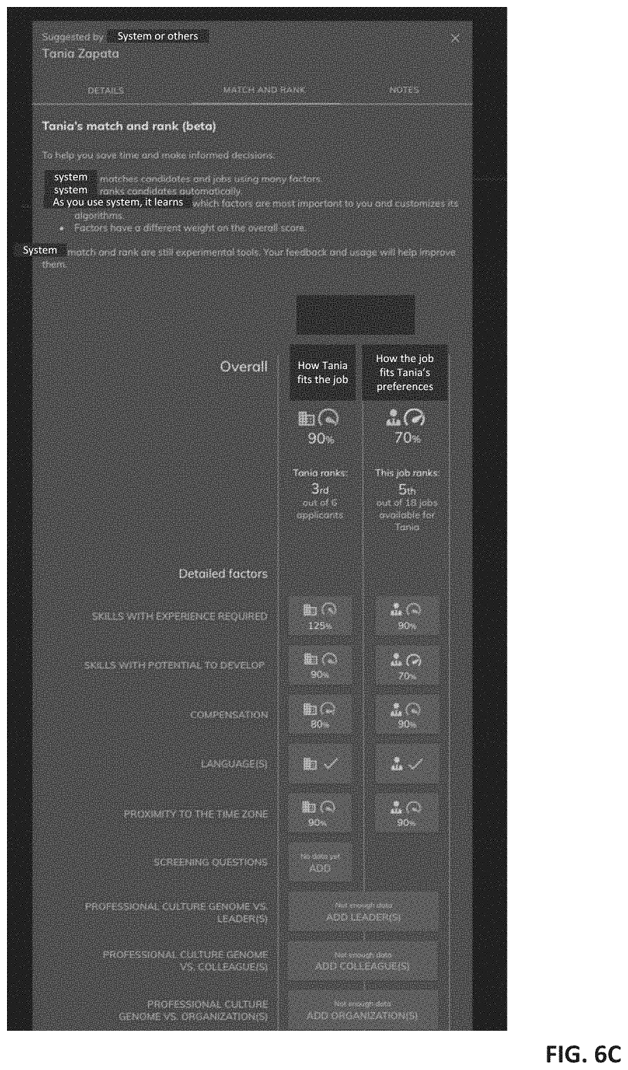

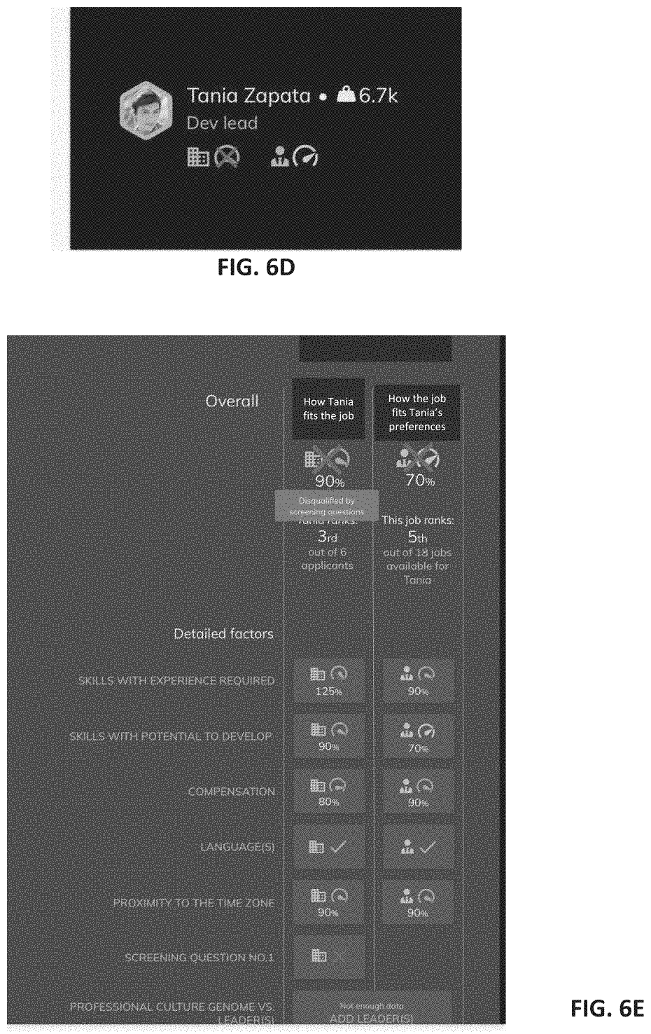

At block 234, the job seeker user can select one of the listed candidate job seeker users to view the candidate job seeker user's profile. At block 236, the system 100 retrieves stored profile data for the selected candidate job seeker user and updates the display window 301 with the profile of the candidate job seeker user. For example, a user viewing the job description in FIG. 4A can also select the “Candidates” tab 411 to view all of the other candidate job seeker users who applied for the job. From such a listing, the job seeker user can select any candidate job seeker user to view detailed information about such user. For example, such information can be displayed in the manner shown in FIG. 6B, which shows exemplary profile information for a candidate job seeker user named “Tania”.

At block 238, the job seeker user can review fitness metrics and rankings for the selected candidate job seeker user by selecting a link from the window updated in block 236. For example, the job seeker user can review fitness metrics and rankings for the selected candidate job seeker user for the job opening. For example, such information can be displayed in the manner shown in FIG. 6C, which shows the fitness metrics and rankings for a selected candidate job seeker user “Tania” for the job opening along with all of the detailed factors and scores used to determine the metrics and rankings.

At block 240, the job seeker user can choose to select one of the factors listed to view detailed information about the score in block 242. The job seeker user can repeat blocks 240 and 242 for multiple factors. The process B ends at D, which returns to block 212 (FIG. 2A1) of workflow 200A.

Turning back to the workflow 200A of FIG. 2A1, at block 218, the job seeker user can also select a link from the window 301 displayed in block 212 to view and answer screening questions for the job opening. Upon selecting such a link at block 218, the workflow begins process “C”, shown in FIG. 2A4.

As shown in FIG. 2A4, upon selecting the link, the system retrieves stored screening questions submitted by the talent seeker user and displays the questions in window 301 at block 246. At block 248, the job seeker user reviews the screening questions and can record answers to those questions, whereupon the system stores the answers at block 250. Also, at block 250, upon storing the answers to the screening questions, the system 100 updates the fitness metrics and rankings for the job seeker user based on the answers. Process C ends at D, which brings the workflow back to block 225 (FIG. 2A1). The workflow 200A ends if the user chooses not to continue at 225.

Optionally, before ending the workflow at 225, a user can decide to apply for the job opening, which can cause the system to initiate an application submission process, as is known in the art and can include a user electronically submitting a resume and cover letter, for example.

As noted above, the system 100 can calculate fitness metrics even if some information is missing from the job seeker's profile data or if some information is missing from the job opening description. However, if no information is available from the user, the system 100 will not be able determine any of the fitness metrics or rankings. In that case, the system 100 will display icons for both fitness metrics and rankings with a “?” to indicate that the metrics and rankings are not known by the system 100, as shown, for example, in FIG. 4E.

Also, the system 100 may not provide rankings if some information is missing. For example, as shown in FIG. 4F, the system 100 does not display a qualification rank because the user has an incomplete profile data and has not answered a screening question that might disqualify the user for the job regardless of any other score of the detailed factors. For example, if the screening question asks whether the user is legally authorized to work, the system 100 will not rank the job seeker user against other qualified job seeker users since it is unknown whether the user is indeed qualified. A job seeker user wishing to see their rank will be able to use the information in FIG. 4F to quickly note the deficiency so that they can update the missing information (such as by going back to “Questions tab” 413 to answer the questions), which will in turn cause the system 100 to dynamically update the rankings as discussed with respect to process C in FIG. 2E.

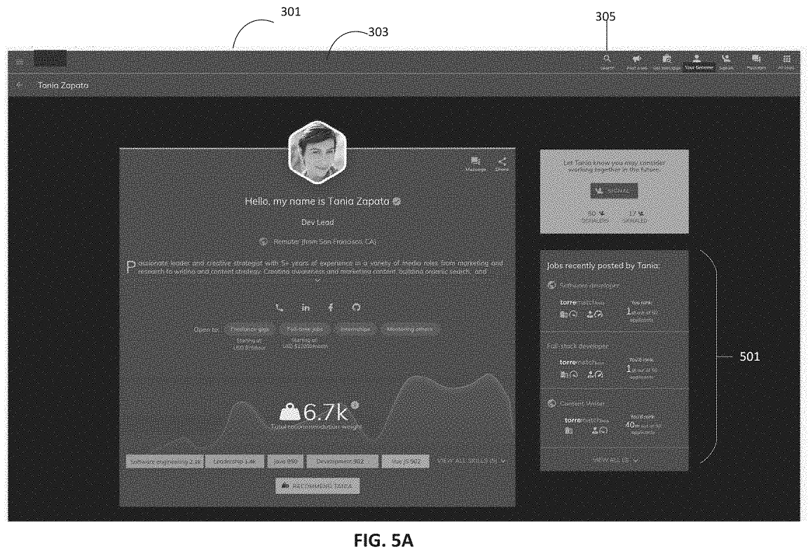

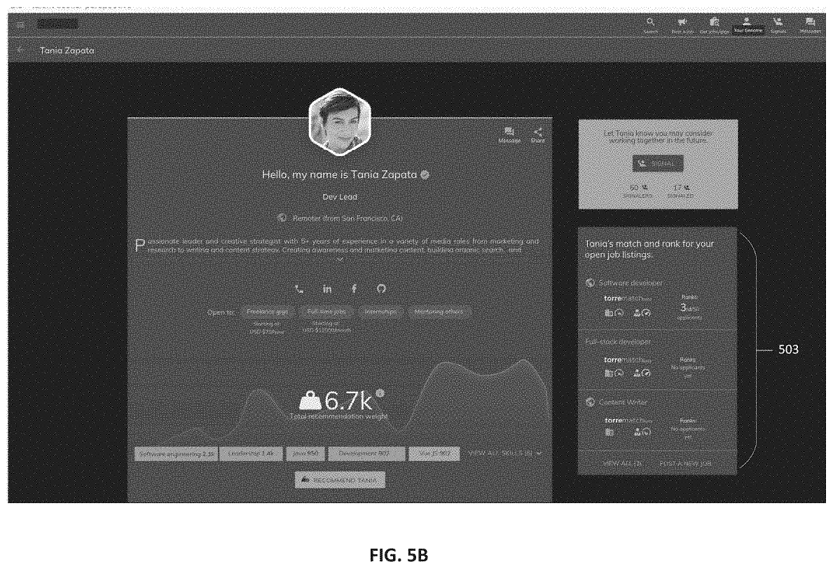

In addition to searching for job openings, a user (e.g., first user, who can be a job seeker user or talent seeker user or both) of the system 100 can also select the “search” tool 305 from the toolbar 303 of the window 301 in FIG. 3 to search for another user (e.g., second user, who can be a job seeker user or talent seeker user or both). Such search queries are known in the art. Upon finding the second user, the first user can select the second user to obtain more information about the second user. Selecting the second user will cause the system 100 to update the image in window 301, such as to display the profile of the second job seeker user as shown in FIGS. 5A and 5B. FIGS. 5A and 5B show the profile data pertaining to the second user along with a listing of job openings 501 posted by the second user (shown in FIG. 5A) as well as a listing of job opening 503 the first user has posted (shown in FIG. 5B). For the listing of job openings 501 posted by the second user in FIG. 5A, the system 100 displays fitness metrics and rankings of the first user for each job opening posted by the second user. For the listing of the job opening 503 posted by the first user in FIG. 5B, the system 100 displays fitness metrics and rankings of the second user for each job opening posted by the first user.

Turing to the workflow 200B of FIG. 2B, the workflow begins at block 251 where the system 100 stores job opening data in the data storage. The job opening data includes job opening data pertaining to a particular job opening submitted by the talent seeker user.

At block 253, the talent seeker user interacts with the system to generate or update the display window 301 to present a chart, such as the Kanban chart 601 (FIG. 6A) showing candidate job seeker users for the particular job opening in various stages of a recruitment process. The talent seeker user can select a job opening from the listing to cause the system 100 to update the window 310 with the Kanban chart 601.

As shown in FIG. 6A, the Kanban chart 601 can be used to give talent seeker users visibility into the status of the recruitment process for the posted job opening. The talent seeker user who posted the job opening is able to view the status of recruitment activities in a recruitment Kanban chart displayed in a window accessible by the talent seeker user who posted the job opening. Kanban charts are well known in recruitment and show a progression (when read from left to right) of progress in the recruitment process to fill a position. Specifically, all possible candidates for the job opening (including those who applied and those who were suggested and did not apply) are shown on the chart.

In the Kanban chart 601 shown in FIG. 6A, every candidate job seeker user is shown along with two aforementioned fitness metrics, namely a job qualification fitness metric and a job fitness metric. The job qualification fitness metric is a measure of how well a job seeker user's qualifications match the requirements of a particular job opening posted by the talent seeker user. The job fitness metric is a measure of how well the aspects of the job opening match personal criteria or preferences of the talent seeker. The requirements and aspects of the job are determined by the talent seeker user when inputting the job opening into the system 100. The personal criteria are derived from the user's profile data established during registration of the job seeker user at block 204 or 230, as discussed in greater detail below.

The chart 601 provides an overview of all candidate job seeker user's fitness to the job opening and the job's fitness to the candidate job seeker users. Four columns of the chart 601 are shown in FIG. 6A. The first column (on the left of the chart) 603 is titled “Suggested by System or others” and lists all users of the system 100 who were automatically suggested for the job “Senior Full Stack Engineer” by the system 100 or by other users. In the example, there are one hundred and fifty users who were suggested for the job opening “Senior Full Stack Engineer”. Each of the suggested users for the job opening are listed by name along with their respective fitness metrics. A second column (from the left) 605 of the Kanban chart 601 is titled “Manually invited (sourced)” and lists all users who were manually invited by the talent seeker to apply, but who have not yet applied. Every listed user in the second column 605 is shown with their fitness metrics in the same manner as the users listed in the first column 603.

The third column 607 is titled “Applied” and lists any job seeker user who has applied for the job opening, e.g., “Senior Full-stack Engineer” along with their fitness metrics and qualification fitness ranking. In the example, the rankings shown are the qualification fitness metric rankings among the candidates who applied for the job opening. The applied candidates are automatically listed in rank order. Also or alternatively, the system 100 may display the job fitness ranking of the candidates.

The fourth column 609 is titled “Mutual matches” and lists candidate job seeker users that are the best fit for the job opening and for whom the job opening is the best fit. That is, the mutual matches are users that have qualification fitness metrics and job fitness metrics of at least 100%. In the example, the candidate with the highest job qualification fitness ranking (e.g., ranked first) is listed as a mutual match.

Candidate job seeker users from one column of the Kanban chart can move to other columns over time to reflect changes in the recruitment process for the job opening. For example, one or more job seeker users who have been recommended by the system 100 may move to the second column if the user decides to manually invite them to apply for the job opening. Likewise, the job seeker user in the fourth column who is a mutual match may be moved to a fifth column (not shown) which may be for all candidate job seeker users who are contacted with an offer of employment or yet another column for candidates who have accepted the offer.

At blocks 255 and 257 of workflow 200B, if a talent seeker user viewing the Kanban chart 601 wishes to delve further into why a listed candidate job seeker user is not a mutual match, the talent seeker user can select any candidate from the Kanban chart to view additional details about the underlying factors associated with the fitness metrics. For example, the talent seeker user may select a suggested candidate job seeker user “Tania” from the first column 603 of the Kanban chart, which will in turn cause the system 100 to retrieve profile data of the selected candidate and display the profile data in the window shown in FIG. 6B. As shown in FIG. 6B, the system displays text stating that Tania was referred by the system and has not applied for the job opening.

At block 259, a talent seeker user who wishes to delve even deeper into the detailed factor scores underlying the qualification fitness metric and/or job fitness metric can click on a “Match and Rank” tab in FIG. 6B, which will cause the system 100 to display the table in FIG. 6C, as shown in block 261 of workflow 200B.

FIG. 6C shows fitness metrics and rankings for job seeker user “Tania” for the job opening along with all of the detailed factors and scores used to determine the metrics and rankings. The fitness metrics include an overall score and rank of fitness of the respective job seeker user “Tania” to the job opening (in this case 90% and rank 3rd of 6 applicants) as well as an overall score and rank of fitness of the job opening to the preferences of the respective job seeker user “Tania” (in this case, 70% score, and 5th of 18 job openings). The overall score and rank of fitness of the respective job seeker user “Tania” to the job opening is associated with the label “How Tania fits the job” in the middle column of the table of FIG. 6C, whereas the overall score and rank of fitness of the job opening to the preferences of the respective job seeker user “Tania” is associated with the label “How the job fits Tania's preferences” in the right column of the table of FIG. 6C. The detailed factors and scores used to determine the overall qualification fitness metric and ranking for job seeker user “Tania” for the job opening are depicted in the first and second columns of the table below the overall score and rank of fitness of the respective job seeker user “Tania” to the job opening. The detailed factors and scores used to determine the overall job fitness metric and ranking of the job opening to the preferences of the respective job seeker user “Tania” are depicted in the first and third columns of the table below the overall score and rank of fitness of the job opening to the preferences of the respective job seeker user “Tania”.

In the table shown in FIG. 6C, some of the scores for the factors are not shown because information has not been input by the talent seeker user. At block 263, the talent seeker user can click on the areas of missing information, whereupon the system 100 will prompt the talent seeker user to input the missing information and store it. Otherwise, at block 265, the talent seeker user can obtain more information about any one of the factors shown in the table of FIG. 6C by selecting a particular factor, which will cause the system 100 to display a detailed analysis at block 267. At block 269, the system checks whether the talent seeker user wishes to continue. If so, the operations return to block 253; otherwise the operations end.

Examples of the detailed analysis of block 267 are shown in FIG. 4F, where fitness metrics are displayed with their scores for the job seeker user “Tania.” Below the fitness scores, the system 100 displays a listing of job requirements related to the detailed factor next to another listing of Tania's qualifications matched to each job requirement. Note that because Tania's skills exceed the job requirements, her score for the factor “Skills with Required Experience” exceeds 100%.

As shown in FIG. 6C, no screening questions have been input into the job description by the talent seeker user. Thus, for the factor “Screening questions”, the system 100 displays “No data yet” in the listed score. FIGS. 6D and 6E show how the system 100 dynamically update the information in FIGS. 6A and 6B when the talent seeker adds a screening question to the job description and when a job seeker user does not positively answer the screening question.

In embodiments, the information shown in FIGS. 6A and 6B can be further annotated by the system 100 to facilitate review by a talent seeker user. Usually, job boards that display any ranking or metrics, do not alert a viewer that there are disqualifying factors that take precedence over all other factors for determining a job match. This deficiency is remedied by an embodiment of the system 100 described herein that displays indicia, which at first sight, are recognizable as disqualification factors indicating the job seeker user is not a match for the job. For example, FIG. 6D shows the information displayed in FIG. 6A for Tania annotated with a red “X” icon displayed over the tachometer icon for the qualification fitness metric. The red “X” indicates that Tania is disqualified for the job due to her answers to the screening question factor. This can simplify review of the information in FIG. 6A by a talent seeker user by providing a prominent indicator in the Kanban chart that the candidate is disqualified without having to delve any further into the detailed scores of the fitness metrics. Moreover, in embodiments, if the talent seeker user does wish to inquire even further into which specific factor(s) disqualify Tania for the job, the talent seeker user can select the red “X” icon, which in turn will cause the system 100 to display the window shown in FIG. 6E.

FIG. 6E includes the same information as shown in FIG. 6C except that the system 100 has updated the list of factors to include “Screening question 1” and has scored the factor with a red “X”. This red “X” indicates that Tania does not meet the screening question criteria for the job opening. In the example, the screening question is a qualifying question. Thus, Tania's failure to positively respond to the screening question disqualifies her completely for the posted job opening, regardless of any of the other scores listed. In the case of the example shown in FIG. 6E, the system 100 also displays an explanation box near (e.g., under) the qualification fitness metric that explains the reason why Tania is disqualified for the job is due to screening questions. By having this information readily viewable, a talent seeker can quickly review this reason and move onto to other candidates without having to delve into any of the other factors listed.

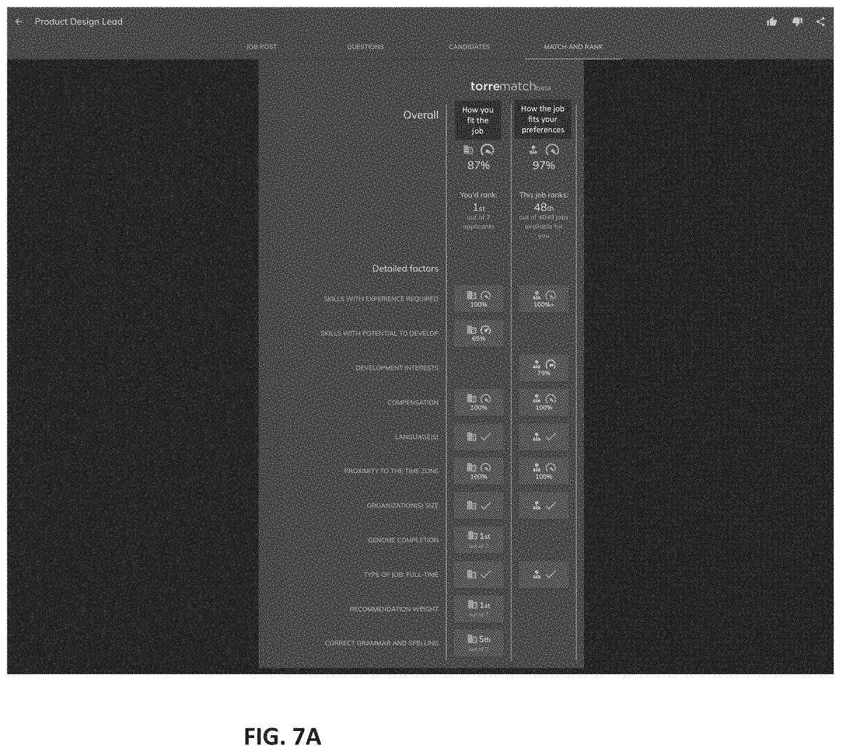

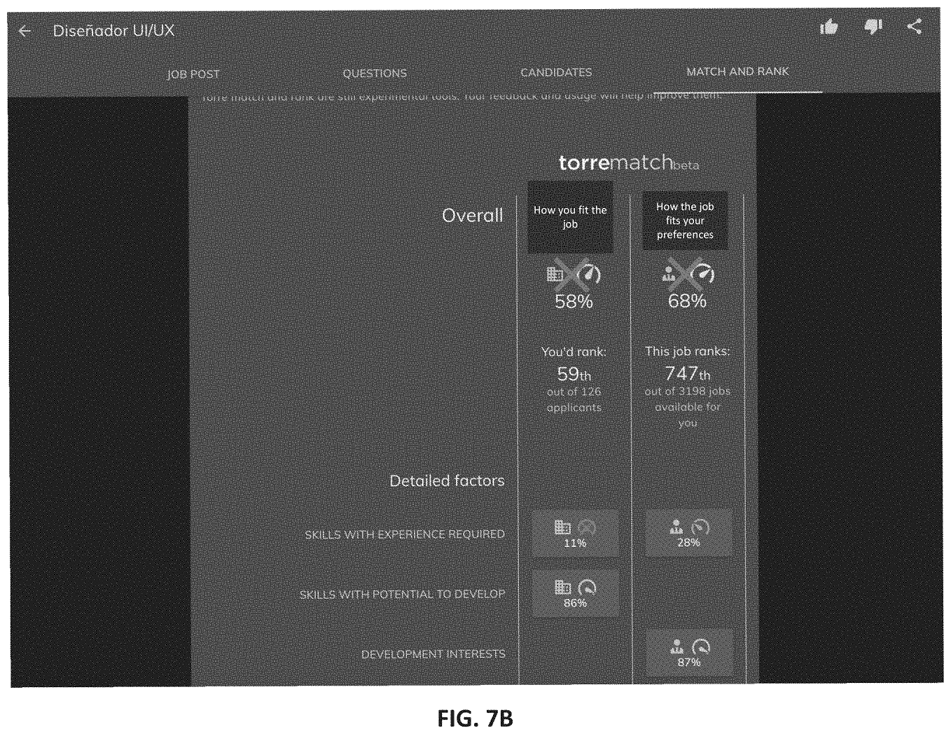

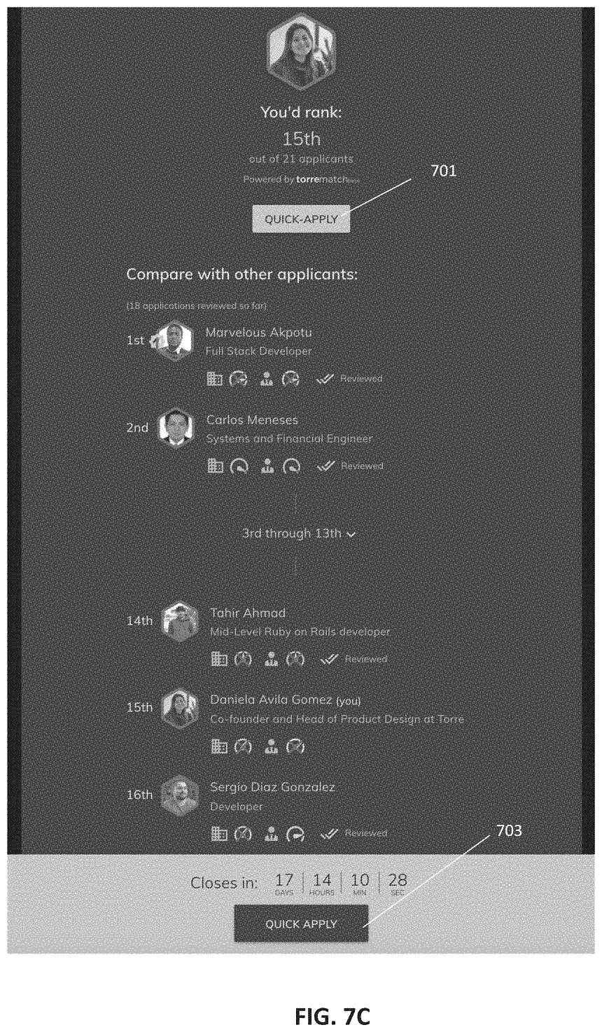

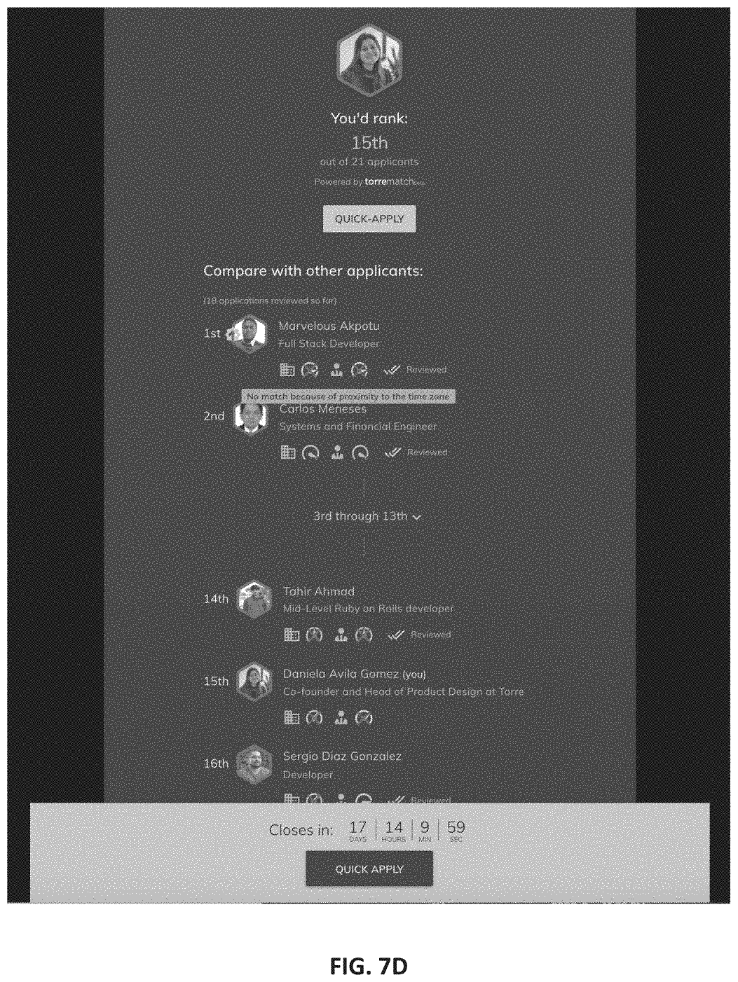

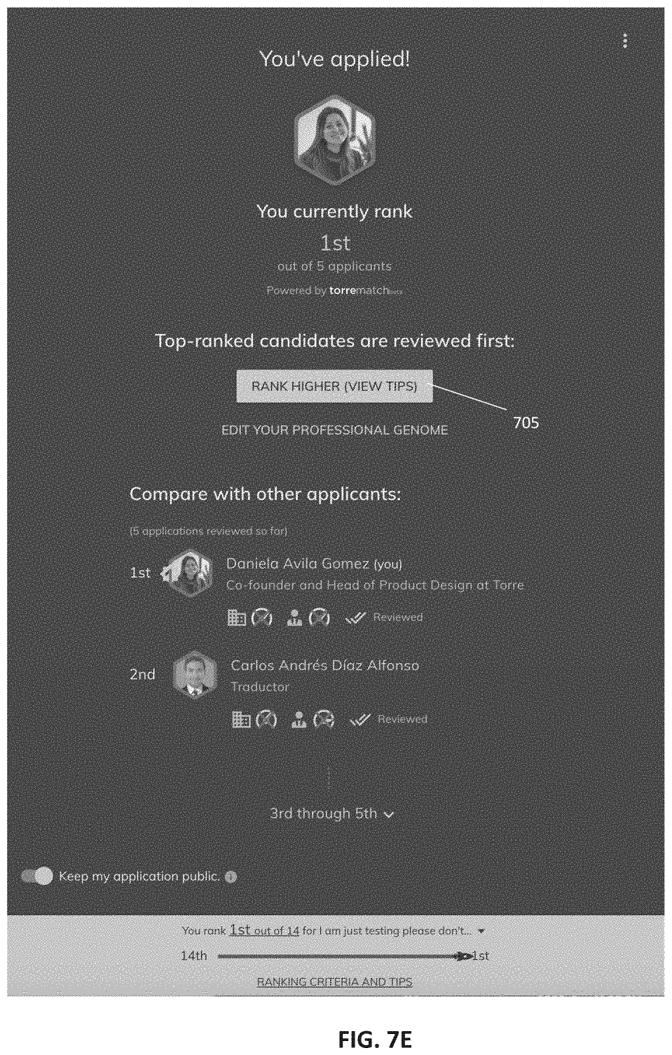

The system 100 can also be configured to enable a given job seeker user to select a particular job opening and review the fitness metrics and rankings of the given job seeker user for the particular job opening. For example, FIG. 7A shows a display window that is presented to a given job seeker user, which depicts the fitness metrics and rankings of the given job seeker user for a particular job opening (e.g., labeled “Product Design Lead”) in a table. The display window also presets detailed factors and metrics or scores used to determine the fitness metrics and rankings of the given job seeker user for the particular job opening. The top of the display window depicts the overall score of fitness and rank (in this case 87% score and 1st rank of 7 applicants) of the given job seeker user to the particular job opening adjacent to the overall score of fitness and rank (in this case 97% score and 48th rank of 4049 job openings) of the particular job opening to the preferences of the given job seeker user. The overall score of fitness and rank of the given job seeker user to the particular job opening is associated with the label “How you fit the job” in the middle column of the table, whereas the overall score of fitness and rank of the particular job opening to the preferences of the given job seeker user is associated with the label “How the job fits your preferences” in the right column of the table. In the left column below and to the left of these fitness scores and rankings, the system 100 displays a listing of job requirements or factors for the particular job opening. In the middle column below the fitness score and ranking (in this case, 87% score, and 1st rank of 7 applicants) of the given job seeker user to the particular job opening, the system displays a first set of detailed factor scores or check boxes that are associated with the list of job requirements or factors. This first set of factor scores and check boxes are derived by matching the qualifications of the given job seeker user to each job requirement or factor of the particular job opening. In the right column below the fitness score and rank (in this case, 97% score and 48th rank of 4049 job openings) of the particular job opening to the preferences of the given job seeker user, the system 100 displays a second set of factor scores or check boxes that are associated with the list of job requirements or factors. This second set of factor scores and check boxes are derived by matching the given job seeker user's preferences to each job requirement or factor of the particular job opening. In the display window shown in FIG. 7A, some of the scores for the factors are not shown because information has not been input by the job seeker user or talent seeker user. In this case, the user can click on the areas of missing information, whereupon the system 100 will prompt the user to input the missing information and store it. Furthermore, by selecting a particular factor, the system 100 can display a detailed analysis of the factor.

FIG. 7B includes information similar that shown in FIG. 7A except that the system 100 has updated the list of factors to include a red “X” adjacent the score for the “SKILLS WITH EXPERIENCE REQUIRED” factor. This red “X” indicates that the given job seeker user does not meet the criteria of the “SKILLS WITH EXPERIENCE REQUIRED” factor for the particular job opening, which disqualifies the respective job seeker user from the particular job opening. The system 100 can also present the display window to depict a red “X” adjacent the overall score of fitness of the given job seeker user to the job opening (in this case, 58% score) to indicate that the given job seeker user is disqualified from the job opening. The system 100 can also present the display window to depict a red “X” adjacent the overall score of fitness of the job opening to the preferences of the given job seeker user (in this case, 68% score) to indicate that the given job seeker user is disqualified from the job opening.

FIG. 7C shows a display window presented to a given job seeker that allows the given job seeker to review the fitness ranking (e.g., 15th out of 21 applicants) of the given job seeker user for a particular job opening along with the rankings, usernames, current job title, fitness scores (e.g., tachometers), and “Reviewed” status for other applicants of the particular job opening. The given job seeker user can click on any one of these other applicant job seeker users to review the factor scores and profile of the selected applicant job seeker user to better understand the rankings of the respective job seeker users. In this case, the given job seeker user has yet to apply for the particular job opening but can do so by clicking on either one of the “QUICK APPLY” buttons 701, 703.

The given job seeker user can also click on any red “X” icon which indicates disqualification of the applicant user for the job opening in order to view information that summarizes the reason for the disqualification, for example as shown in FIG. 7D.

FIG. 7E shows a display window presented to a given job seeker that depicts the fitness ranking (e.g., 1st out of 5 applicants) of the given job seeker user for a particular job opening after the job seeker user has applied for the particular job opening. Similar to the display window of FIG. 7C, it also depicts the rankings, usernames, current job title, fitness scores (gauges), and “Reviewed” status for other applicants of the particular job opening. The given job seeker user can click on the “RANK HIGHER (VIEW TIPS)” button 705 to view tips and initiate editing his or her profile data, if desired, in order to improve the fitness ranking of the given job seeker user for the particular job opening.

The system 100 can also provide additional functionality for user interaction and social networking such as that described in U.S. Patent Application Publication 2019/0188806, which is incorporated herein in its entirety. For example, window 301 has a toolbar 303 with a plurality of user-selectable tools entitled: “signals” 313, and “messages” 315.

The “signals” tool 313 in the toolbar 303 refers to indications from other users that they would like to work with the user (e.g., on a job or project) viewing the window 301. A user can generate new signals or review prior received or sent signals by selecting the “signals” toolbar 313 from the toolbar 303, which causes the system 100 to update the display window 301 with a signaling window that can provide the user with an interface to generate new signals, as well as review signals from other users as well as all signals previously sent by the user.

Also, the “messages” tool 315 in the toolbar 303 refers to electronic messages between the logged in user and any other user of the system 100. A user who wishes to review their messages or to send a message to another user can select the “messages” icon from the toolbar which will display a messaging interface, as is known in the art.

In an exemplary embodiment, the qualification scores (metrics) and rankings for a job seeker user with respect to a particular job opening and the fitness scores (metrics) of a particular job opening to the preferences of the job seeker user can be determined as follows. Consider an illustrative job opening labeled “Job Opening 1” characterized by the information in Table A below.

TABLE A
Job Opening 1

Skills and Experience-Required
Java-1 + year (12 months)
Python-2 + year (24 months)
Skills and experience with Potential to Develop
Kubernetes
Terraform
Compensation
$40000/yearly
Languages and fluency required
English-Conversational
French-Fully fluent
Location
Remote-United States
Timezone
GMT-8 to GMT-5
Organization
Torre (size: 100)
Type of job
Full-time employment

Consider further an illustrative job seeker user whose name is “Job Seeker User 1” characterized by the information in Table B below.

TABLE B
Job Seeker User 1

Skills and experience
Kotlin-6 months
Java-2 months
Interests to develop
DevOps
AWS
Azure
Compensation
$7500/monthly
Languages and fluency
English-Fully fluent
Location
San Francisco, California
Timezone
GMT-4
Preferred Organization Size
10-1000
Interested in job types
Full-time employment
Freelance/Gigs

The qualification scores and corresponding calculations can consider similarities between skills, which can be defined by a word2vec model trained with job description data. The model can provide for similarity values in the range between 0 (no similarity) and 1 (same) between different skill pairs. An example of the model for the skills of the exemplary job opening of Table A and the job seeker user 1 of Table B is illustrated in Table 3 below.

TABLE 3

| Skill 1 | Skill 2 | Similarity |
|---|---|---|
| Java | Java | 1 |
| Kotlin | Java | 0.8 |
| DevOps | Java | 0.2 |
| AWS | Java | 0.7 |
| Azure | Java | 0.7 |
| Java | Python | 0.7 |
| Kotlin | Python | 0.5 |
| DevOps | Python | 0.4 |
| AWS | Python | 0.5 |
| Azure | Python | 0.4 |
| Java | Kubernetes | 0.5 |
| Kotlin | Kubernetes | 0.1 |
| DevOps | Kubernetes | 0.9 |
| AWS | Kubernetes | 0.8 |
| Azure | Kubernetes | 0.9 |
| Java | Terraform | 0.5 |
| Kotlin | Terraform | 0.1 |
| DevOps | Terraform | 0.85 |
| AWS | Terraform | 0.7 |
| Azure | Terraform | 0.6 |

For example, qualification scores for the skills and experience factors and a total skill qualification score that relates the fitness of the job seeker user to a job opening can be calculated as follows:

Skill/Experience score per particular skill of job seeker user=experience of job seeker user in particular skill (months)/ceil (sum over all skills for job opening (experience in skill required for job opening (months)*similarity for skill in job opening to particular skill of job seeker user)) Eqn. (1A)

Total skill score={sum over all skills of job seeker user (skill/experience score*experience of job seeker user in particular skill (months))}/sum of required experience (months) for the job opening Eqn. (1B)

The calculations of the Skill/Experience factor qualification scores and total skill qualification score for Job Seeker User 1 to Job Opening 1 would thus involve the following:

Experience score for Kotlin=6/ceil(0.8*12+0.5*24)=0.2727 per Eqn. (1A)

Experience score for Java=2/ceil(1.0*12+0.7*24)=0.06 per Eqn. (1A)

Total skill score=(0.2727*6+0.06*2)/36=0.0487 per Eqn. (1B)

Fitness scores for the skills and experience factors and a total skill fitness score that relates fitness of a job opening to the preferences or interests of a job seeker user can be calculated as follows:

Skill/Experience score per particular skill of job opening=ceil{sum over all skills of job seeker user (experience of job seeker user in skill (months)*similarity of skill of job seeker user to particular skill in job opening)/experience of the particular skill (in months) required for job opening} Eqn. (2A)

Total skill score=weighted average of skill/experience scores, where weight for a given skill/experience score is given as experience of the particular skill (in months) required for job opening/total experience (in months) of all skills required for job opening Eqn. (2B)

The calculations of the Skill/Experience factor fitness scores and total skill fitness score for Job Opening 1 to Job Seeker User 1 would thus involve the following:

Experience score for Java=ceil(2*1.0+6*0.8)/12=0.5833 per Eqn. (2A)

Experience score for Python=ceil(2*0.7+6*0.5)/24=0.2083 per Eqn. (2A)

Experience score for Kubernetes=discarded because of potential to develop per Eqn. (2A)

Total skill score=(12*0.5833+24*0.2083)/36=0.3333 per Eqn. (2B)

The qualification score for the skills and experience with potential to develop factor that relates the fitness of the job seeker user to a job opening can be calculated as follows:

Average of similarity scores between Job Seeker User's Interest to Develop and Job Opening Skills to Develop for up to 3 highest similarity scores Eqn. (3)

The calculations of the Skill/Experience with potential to develop factor qualification score for Job Seeker User 1 to Job Opening 1 would thus involve the following:

Total score=0.9 (DevOps−Kubernetes)+0.9 (Azure−Kubernetes)+0.85 (DevOps−Terraform)=2.65/3=0.8833 per Eqn. (3)

The fitness score for the Interest to develop factor that relates the fitness of a job opening to the preferences or interests of a job seeker user can be calculated as follows:

Average of similarity scores between Job Seeker User's Interest to Develop and Job Opening Skills to Develop for up to 3 highest similarity scores Eqn. (4)

The calculations of the fitness score for the Interest to develop factor for Job Opening 1 to Job Seeker User 1 would thus involve the following:

Score=0.9 (DevOps−Kubernetes)+0.9 (Azure−Kubernetes)+0.85 (DevOps−Terraform)=2.65/3=0.8833 per Eqn. (4)

The qualification score for the compensation factor that relates the fitness of the job seeker user to a job opening can be calculated as follows:

Normalize the compensation values for the job opening and the job seeker user to hourly compensation values Eqn. (5A)

Score=1−{(normalized hourly compensation for job seeker user−normalized hourly compensation for job opening)/normalized hourly compensation for job seeker user} Eqn. (5B)

The calculations of the qualification score for the compensation factor for Job Seeker User 1 to the Job Opening 1 would thus involve the following:

Normalize compensation for Job Opening 1: 40000/yearly=20.83/hour, which assumes working 48 weeks per year and 40 hours/week per Eqn. (5A)

Normalize compensation for Job seek user 1: 7500/month=90000/yearly=46.875/hourly per Eqn. (5A)

Score=1−(46.875−20.83)/46.875=0.4443 per Eqn. (5B)

The fitness score for the compensation factor that relates the fitness of a job opening to the preferences or interests of a job seeker user can be calculated as follows:

Score=normalized hourly compensation for job opening/normalized hourly compensation for job seeker user Eqn. (6)

The calculation of the fitness score for the compensation factor for Job Opening 1 to Job Seeker User 1 would thus involve the following:

Score=20.83/46.875=0.4443 per Eqn. (6)

The qualification score for the languages factor that relates the fitness of the job seeker user to a job opening can be calculated as follows:

Score per language: below required fluency=0.2; same as required fluency=1.0; above required fluency=1.0 Eqn. (7A)

score=average of the per-language scores Eqn. (7B)

The calculation of the qualification score for the language factor for Job Seeker User 1 to Job Opening 1 would thus involve the following:

English score=1.0 per Eqn. (7A)

French score=0.2 per Eqn. (7A)

score (average of scores)=1.0+0.2/2=0.6 per Eqn. (7B)

The qualification score for the proximity to time zone factor that relates the fitness of the job seeker user to a job opening can be calculated as follows:

score=1−{time difference to closest time zone (in millis)/12*3600*1000} Eqn. (8)

The calculation of the qualification score for the proximity to time zone factor for Job Seeker User 1 to Job Opening 1 would thus involve the following:

score=1−(3600000/12*3600*1000)=0.9166 per Eqn. (8)

The fitness score for the proximity to time zone factor that relates the fitness of the job opening to the preferences of the job seeker user can be calculated as follows:

score=1−{time difference to closest time zone (in millis)/3*3600*1000} Eqn. (9)

where the integer 3 represents the difference (in hours) from the target time zone of the job seeker user that is considered too far away from the job seeker user; this value can be changed if desired.

The calculation of the fitness score for the proximity to time zone factor for the Job Opening 1 to Job Seeker User 1 would thus involve the following:

score=1−(3600000/3*3600*1000)=0.6666 per Eqn. (9)

The qualification metrics that relate the fitness of the job seeker user to a job opening can also include one or more indicators or flags that can be assigned to certain predefined data values, such “Approved” or “Disapproved” or other data values. These values can be used as criteria for scoring or ranking the fitness of the job seeker user to a job opening. Similarly, the fitness metrics that relate the fitness of the job opening to the preferences or interests of a job seeker user can also include one or more indicators or flags that can be assigned to certain predefined data values such “Approved” or “Disapproved” or other data values. These values can also be used as criteria for scoring or ranking the fitness of the job opening to the preferences or interests of the job seeker user.

For example, a qualification metric for the proximity to location factor that relates the fitness of the job seeker user to a job opening can be calculated as follows:

metric=“Approved” if Job Opening location intersects with Job Seeker User's location Eqn. (10a)

metric=“Disapproved” if Job Opening location does not intersect with Job Seeker User's location Eqn. (10b)

The calculation of the qualification metric for the proximity to location factor for Job Seeker User 1 to Job Opening 1 would thus involve the following:

metric=“Approved” because the location of Job Opening 1 intersects with the location of Job Seeker User 1 per Eqn. (10a)

A qualification metric for the organization size factor that relates the fitness of the job seeker user to a job opening can be calculated as follows:

metric=“Approved” if the organization size of the job opening is within range of the job seeker user's preferences for organization size Eqn. (11a)

metric=“Disapproved” if the organization size of the job opening is outside the range of the job seeker user's preferences for organization size Eqn. (11b)

The calculation of the qualification metric for the organization size factor for Job Seeker User 1 to Job Opening 1 would thus involve the following:

metric=“Approved” because the organization size of Job Opening 1 is within range of Job Seeker User 1's preferences for organization size per Eqn. (11a)

A fitness metric for the organization size factor that relates the fitness of the job opening to the preferences of the job seeker user can be calculated as follows:

metric=“Approved” if the organization size of the job opening is within range of the job seeker user's preferences for organization size Eqn. (12a)

metric=“Disapproved” if the organization size of the job opening is outside the range of the job seeker user's preferences for organization size Eqn. (12b)

The calculation of the fitness metric for the organization size factor for Job Opening 1 to Job Seeker User 1 would thus involve the following:

metric=“Approved” because the organization size of Job Opening 1 is within range of Job Seeker User 1's preferences for organization size per Eqn. (12a)

A qualification metric for the job type factor that relates the fitness of the job seeker user to a job opening can be calculated as follows:

metric=“Approved” if the job type of the job opening matches any job type preference of the job seeker user Eqn. (13a)

metric=“Disapproved” if the job type of the job opening does not match any job type preference of the job seeker user Eqn. (13b)

The calculation of the qualification metric for the job type factor for Job Seeker User 1 to Job Opening 1 would thus involve the following:

metric=“Approved” because the job type of Job Opening 1 matches a job type preference of Job Seeker User 1 per Eqn. (13a)

A fitness metric for the job type factor that relates the fitness of the job opening to the preferences of the job seeker user can be calculated as follows:

metric=“Approved” if the job type of the job opening matches any job type preference of the job seeker user Eqn. (14a)

metric=“Disapproved” if the job type of the job opening does not match any job type preference of the job seeker user Eqn. (14b)

The calculation of the fitness metric for the job type factor for Job Opening 1 to Job Seeker User 1 would thus involve the following:

Metric=“Approved” because the job type of Job Opening 1 matches a job type preference of Job Seeker User 1 per Eqn. (14a)

A total score that relates the fitness of the job seeker user to a job opening can be calculated from the corresponding factor scores above as follows:

Total score=average of all defined factor scores for Job Seeker User to Job Opening Eqn. (15)

The calculation of the total score for Job Opening 1 to Job Seeker User 1 would thus involve the following:
Skills/Experience factor score=0.0487
Skills with potential to develop factor score=0.8833
Compensation factor score=0.4443
Language factor score=0.6
Proximity to timezone factor score=0.9166

Total score=(0.0487+0.8833+0.4443+0.6+0.9166)/5=0.5783 per Eqn. (15)

A total score that relates the fitness of the job opening to the preferences of the job seeker user can be calculated from the corresponding factor scores above as follows:

Total score=average of all defined factor scores for Job Opening to Job Seeker User Eqn. (16)

The calculation of the total score for Job Seeker User 1 to Job Opening 1 would thus involve the following:
Skills/Experience factor score=0.3333
Development interests factor score=0.8833
Compensation factor score=0.4443
Proximity to timezone factor score=0.6666

Total score=(0.3333+0.8833+0.4443+0.6666)/4=0.5815 per Eqn. (16)

The process can also calculate a score for correct grammar and spelling of a job seeker user with respect to a job opening as follows:

Score=1−(number of grammatical or spelling errors in job seeker user profile/number of words in the profile of the job seeker user) Eqn. (17)

The calculation of the score for correct grammar and spelling of Job Seeker User 1 to Job Opening 1 would thus involve the following:

Score=1−(2/400)=0.995 per Eqn. (17)

The calculation of the factor scores and metric and total scores can be performed by the system. In other embodiments, the system can be configured to perform other calculations or use other scoring metrics to relate the fitness of a job seeker user to a job opening and also relate the fitness of a job opening to the preferences of a job seeker user. Such metrics can be added or used as substitutes for the exemplary factor scores and total scores described herein. Such scores and metrics can be presented for display to users of the system in one or more display windows as described herein.

Various modifications are possible to the embodiments described above. According to another aspect of the disclosure, the job seeker and/or the talent seeker are not users of the system, but their information is imported or otherwise received from external data sources, such as third party databases to which the system can be granted access. For example, they system may be used to match candidates with job postings even if the candidates have profiles stored on databases other than data store 120. One example of this would be if a candidate has a profile stored on a first job database, but who wishes to use the system 100 to search for job or to have his profile searchable to talent seekers using the system 100. Also, talent seekers may post jobs on a second job database different from data store 120 but wish to make the job postings searchable to users of the system 100.

In yet other embodiments, the talent seeker performs a search for candidates having some degree of matching certain job qualification criteria and job fitness criteria. For example, a talent seeker may generate a search query for the system that includes job qualification criteria and personal job fitness criteria that can be input to the system. For each search, the system can return or otherwise output (e.g., visually in a display window) search results that include a plurality of candidates that match at least some of the searched criteria. Thus, the plurality of candidates have job qualifications that match (to at least some degree) the job qualifications the talent seeker is looking for and the listed candidates match (to at least some degree) the personal criteria the talent seeker is looking for in a candidate. The matched candidates may be ranked against one another based on the degree to which their qualifications or personal requirements match those of the criteria posted by the talent seeker Thus, the criteria queried by the talent seeker are used as the factors by which each candidate is quantitatively scored and ranked. For example, the job qualifications queried by the talent seeker can be used to rank the matched candidates based on their job qualifications fitness metrics for a job requiring the queried job requirements.

Also in embodiments, the system ranks talent seeker searches for a particular candidate. This ranking can be used as an indicator of how in-demand the candidate is in the labor market. For example, a first talent seeker (e.g., representing company A) and a second talent seeker (e.g., representing company B) both conduct separate candidate searches that both identify the same candidate as a match. Any user of the system, including the candidate, who reviews the profile of the candidate will be able to see that the candidate was searched by the first and second talent seekers, although in some embodiments, the identity of the talent seekers may be concealed. Nevertheless, the attributes of the two talent seekers may be visible to a reviewer and can be used to rank the searches of the talent seekers and, thereby, rank the talent seekers.

For example, a first talent seeker or company represented by the first talent seeker is not in a field of interest to the candidate, but a second talent seeker or company represented by the second talent seeker is in a field of inters tot the candidate. The system can rank the first talent seeker's search lower than the second talent seeker's search since the candidate is more marketable to the second talent seeker.

Other factors that can be used to rank the talent seeker searches include the reputation of the talent seeker or company represented by the talent seeker. For example, search results from companies or talent seekers with a lower reputation may be ranked lower than those companies or talent seekers with a higher reputation.

Also, the search results of the talent seekers (or companies represented by the talent seekers) may be ranked based on whether or not the employees of the talent seeker (or company) are recognized in the areas of interest of the candidate. For example, search results of a company who has employees who are working in the areas of interest to the candidate may be ranked higher than the search results of companies who do not have employees who are working in the areas of interest.

Also, the search results of talent seekers (or companies represented by the talent seekers) may be ranked based on how closely connected the talent seeker (and its employees) are to the contacts of the candidate. For example, if the talent seeker (or company it represents) and its employees are closely connected to people the candidate knows, then that talent seeker's search may be ranked more highly than the search of another talent seeker (or company it represents) who's employees are not closely connected to people the candidate knows.

Other factors that may be used to rank the searches of talent seekers (or companies represented by talent seekers) are the compatibility of the required skills and experience with the skills and experience of candidate. For example, if the search criteria requires a much higher level of skills than the candidate possesses, then the search can be ranked lower than another search that requires skills more closely matching skills that the candidate possesses. Thus, searches by talent seekers (or companies) for whom the candidate is less qualified can be ranked lower, indicating there will be less competition for the candidate with the talent seeker (or company) who conducted the lower ranked search. By way of example, one skill that may be a requirement in the job criteria specified in a talent seeker search is a required language. For example, if a talent seeker's search criteria includes a language requirement, the search can be ranked based on the compatibility with the candidate's skills. Thus, searches requiring a language that the candidate does not speak will be ranked lower than searches that do not require that language. On the other hand, if the candidate lacks skills (e.g., language skills) or experience required for the job, but has development interests (e.g., aspirations for learning the skills or gaining experience), the search may be ranked higher than if the candidate had no development interests, since the candidate has an interest in developing skills and growing into a position requiring the missing skills.

Another factor that may be considered in ranking the searches of talent seekers is compensation matching the expectations of the candidate. For example, searches that include compensation criteria that more closely match the expectations of the candidate may be ranked higher than searches with compensation criteria that are further from compensation expectations of the candidate.

Another factor that may be considered in ranking the searches of talent seekers is proximity of the candidate to the talent seeker. For example, in embodiments, the closer a talent seeker is geographically to the candidate, the higher the talent seeker's search will be ranked. This can reflect a greater desire of the candidate to be located closer to an existing geographical location. Of course, if a candidate has expressed interest in working in a specific geographical area different from his or her existing location, the rankings can be adjusted based on the proximity to the specific area.

Other factors that may be considered in ranking the searches of talent seekers relate to professional culture. For example, one factor that may be used for ranking searches of talent seekers is how compatible the candidate's professional culture is with the professional culture of the leader of the talent seeker (or company represented by the talent seeker). Another factor that may be used for ranking searches of talent seekers is how compatible the candidate's professional culture is with the professional culture of employees of the talent seeker (or company represented by the talent seeker). Yet another factor that may be used for ranking searches of talent seekers is how compatible the candidate's professional culture is with the professional culture of the organization of the talent seeker (or company represented by the talent seeker). For example, the greater the compatibility between the candidate's professional culture and that of the leader, employees, or organization, the higher the ranking of the search.

Another factor that may be considered in ranking the searches of the talent seekers is the size of the company (e.g., number of employees) and whether the size is of interest to the candidate. For example, if the talent seeker represents a company that has a number of employees exceeding a range desired by the candidate (i.e., the organization size is not a good fit because it is too big for the candidate), then the search for the talent seeker may be ranked lower than another search of another talent seeker representing another company that has a number of employees within the range desired by the candidate.

Yet another factor that may be considered in ranking the searches of the talent seekers is whether the search criteria include all the information the candidate is looking for or considering in their employment. For example, a candidate may be considering more criteria in their employment than the criteria used in a search by a first talent seeker. On the other hand, a search by a second talent seeker may have included all the criteria that the candidate considers important in his or her employment. Thus, in that case, the candidate may be more likely to consider employment with the second talent seeker than the first talent seeker. Accordingly, the search of the second talent seeker can be ranked higher than the search of the first talent seeker.

Certain embodiments as described herein can include logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules is embodied by a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

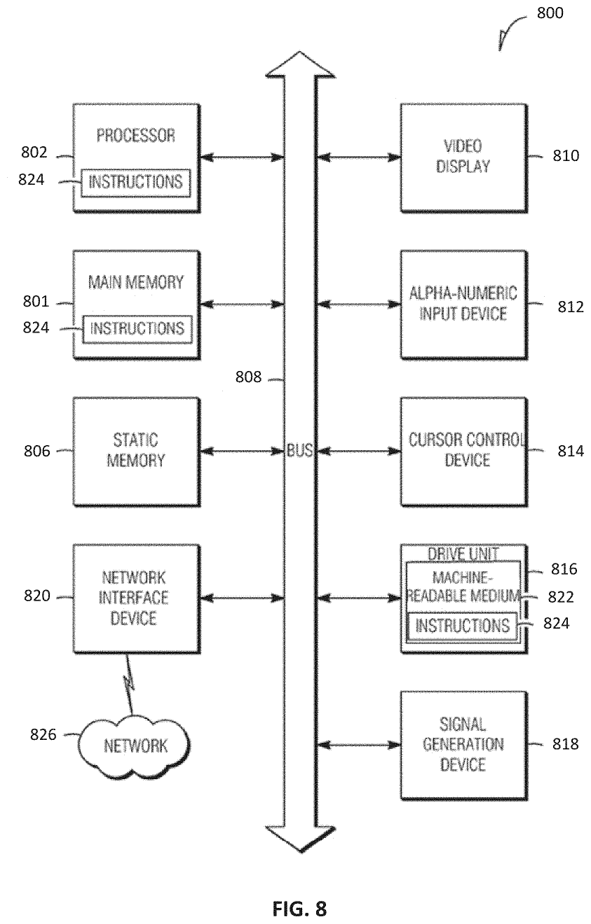

FIG. 8 shows a diagrammatic representation of a machine in the example form of a computer system 800 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Personal Digital Assistant (PDA), a cellular telephone or smartphone, a Web appliance, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 800 includes a processor 802 (e.g., a Central Processing Unit (CPU), a Graphics Processing Unit (GPU) or both), a main memory 801 and a static memory 806, which communicate with each other via a bus 808. The computer system 800 may further include a video display unit 810 (e.g., a Liquid Crystal Display (LCD) or a Cathode Ray Tube (CRT)). The computer system 800 also includes an alphanumeric input device 812 (e.g., a keyboard), a User Interface (UI) cursor controller 814 (e.g., a mouse), a disk drive unit 816, a signal generation device 818 (e.g., a speaker) and a network interface device 820 (e.g., a transmitter).

The disk drive unit 816 includes a machine-readable medium 822 on which is stored one or more sets of instructions 824 and data structures (e.g., software) embodying or used by one or more of the methodologies or functions illustrated herein. The software may also reside, completely or at least partially, within the main memory 801 and/or within the processor 802 during execution thereof by the computer system 800, the main memory 801 and the processor 802 also constituting machine-readable media.

The instructions 824 may further be transmitted or received over a network 826 via the network interface device 820 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a non-exclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A computer-implemented method comprising:
a) storing job requirement data for each job opening of a plurality of job openings;
b) storing profile data for each user of a plurality of users;
c) storing job preference data for each user of the plurality of users;
d) generating a first metric pertaining to a particular job opening belonging to the plurality of job opening and a particular user belonging to the plurality of users based on the requirement data for the particular job opening and the profile data for the particular user;
e) generating a second metric pertaining to the particular job opening and the particular user based on the requirement data for the particular job opening and the job preference data for the particular user; and
f) displaying visual representations of the first metric and the second metric as part of a unitary display window or screen.

2. The method according to claim 1, wherein:
the first metric is a measure of how well qualifications of the particular user match requirements of the particular job opening; and
the second metric is a measure of how well aspects of the job opening match personal criteria or preferences of the particular user.

3. The method according to claim 1, wherein:
the particular user is an applicant or a potential applicant for the particular job opening.

4. The method according to claim 1, wherein:
the unitary display window or screen that includes the visual representation of the first metric and the second metric is presented to the particular user.

5. The method according to claim 1, wherein:
the unitary display window or screen that includes the visual representation of the first metric and the second metric is presented to a talent seeker user that posted the particular job opening.

6. The method according to claim 1, wherein:
the unitary display window or screen that includes the visual representation of the first metric and the second metric is presented to the particular user in conjunction with viewing the user profile of a user that posted the particular job opening.

7. The method according to claim 1, wherein:
the unitary display window or screen that includes the visual representation of the first metric and the second metric is presented to a user that posted the particular job opening in conjunction with viewing the user profile of the particular user.

8. The method according to claim 1, further comprising:
g) repeating d) for a number of additional users;
h) ranking the particular user together the additional users based on values of the first metric for the particular user and the additional users; and
i) displaying the ranking of the particular user in a display window or screen.

9. The method according to claim 8, wherein:
the ranking of the particular user is presented to the particular user.

10. The method according to claim 8, wherein:
the ranking of the particular user is presented to a talent seeker user that posted the particular job opening.

11. The method according to claim 8, wherein:
the ranking of the particular user is presented to the particular user in conjunction with viewing the user profile of a user that posted the particular job opening.

12. The method according to claim 8, wherein:
the ranking of the particular user is presented to a user that posted the particular job opening in conjunction with viewing the user profile of the particular user.

13. The method according to claim 8, further comprising:
displaying the ranking of the particular user together the ranking of additional users.

14. The method according to claim 8, further comprising:
displaying values of the first metric for the particular user and the additional users in a display window or screen.

15. The method according to claim 1, wherein:
the first metric is based on a first plurality of factor scores; and
the second metric is based on a second plurality of factor scores.

16. The method according to claim 15, further comprising:
weighting the first plurality of factor scores to determine the first metric, and
weighting the second plurality of factor scores to determine the second metric.

17. The method according to claim 15, further comprising:
displaying in the display window a table including visual representations of the first plurality of factor scores and visual representations of the second plurality of factor scores.

18. The method according to claim 15, wherein:
the first plurality of factor scores is based on at least one screening question or criteria, wherein the screening question or criteria qualifies or disqualifies the respective user independently of any other factor score of the first plurality of factor scores.

19. The method according to claim 1, wherein:
the first metric is identified by a first visual indicia and the second metric is identified by a second visual indicia different from the first visual indicia.

20. The method according to claim 1, wherein:
the visual representations of the first metric and the second metric comprise visual indicators, including at least one of a gauge and a tachometer.

21. The method according to claim 1, further comprising:
displaying in the window a chart showing a number of users with values of the respective first metric and second metric for a particular job opening, wherein the users in the chart are organized based on their status in a recruitment process.

22. The method according to claim 1, further comprising:
interacting with a user to generate the requirement data for at least one job opening, or receiving the requirement data for at least one job opening from an external data source.

23. The method according to claim 1, further comprising:
interacting with a user to generate the profile data for at least one user, or receiving the profile data for at least one user from an external data source.

24. The method according to claim 1, further comprising:
interacting with a user to generate the job preference data for at least one user, or receiving the job preference data for at least one user from an external data source.

25. A system comprising:
data storage configured to store requirement data for each job opening of a plurality of job openings, profile data for each user of a plurality of users, and job preference data for each user of the plurality of users; and
at least one computer processor that includes:
at least one module configured to generate a first metric pertaining to a particular job opening belonging to the plurality of job opening and a particular user belonging to the plurality of users based on the requirement data for the particular job opening and the profile data for the particular user;
at least one module configured to generate a second metric pertaining to the particular job opening and the particular user based on the requirement data for the particular job opening and the job preference data for the particular user; and
at least one module configured to display a visual representation of the first metric and the second metric as part of a unitary display window or screen.

26. A computer-implemented method comprising:
a) storing job requirement data for each job opening of a plurality of job openings;
b) storing profile data for each job seeker user of a plurality of job seeker users;
c) storing preference data for each job seeker user of the plurality of job seeker users;
d) generating a search query of job seeker users that match the job requirement data of a particular job opening;
e) identifying at least one job seeker user matching the job requirement data of the particular job opening;
f) generating a first metric for each job seeker user identified in e), wherein the first metric quantitatively measures how close the job seeker user matches the job requirement data for the particular job opening;
g) generating a second metric for each job seeker user identified in e), wherein the second metric quantitatively measures how close the job requirement data for the particular job opening matches the preference data of the job seeker user; and
h) displaying visual representations of the first metric and the second metric together as part of a unitary display window or screen.

27. The method according to claim 26, further comprising:
repeating e) to h) for a plurality of job seeker users.

28. The method according to claim 26, further comprising:
repeating d) to h) for a plurality of job openings; and
ranking the plurality of job openings with respect to a particular job seeker user based on at least one of the first metric and the second metric for the particular job seeker user over the plurality of job openings.

29. The method according to claim 28, further comprising:
visually displaying the ranking of the plurality of job openings to the particular job seeker user in conjunction with display of the first metric and the second metric for the particular job seeker user over the plurality of job openings.
